(19) United States
(12) Patent Application Publication
(10) Pub. No.: US 2026/0313333 A1
(43) Pub. Date: Oct. 8, 2026

(54) SENSOR SHARING CONFIGURATION

(71) Applicant: QUALCOMM Incorporated, San Diego, CA (US)

(72) Inventors: Dan Vassilovski, Del Mar, CA (US); Tien Viet Nguyen, Bridgewater, NJ (US); Kapil Gulati, Belle Mead, NJ (US); Shuanshuan Wu, San Diego, CA (US); Hui Guo, Beijing (CN)

(21) Appl. No.: 19/483,136

(22) PCT Filed: Jul. 27, 2023
(86) PCT No.: PCT/CN2023/109474

§ 371 Date: Nov. 10, 2025

(51) Int. Cl. H04W 4/40; H04W 64/00; H04W 76/20; H04W 92/18

(52) U.S. Cl. CPC H04W 4/40; H04W 64/006; H04W 76/20; H04W 92/18

(57) ABSTRACT

This disclosure provides systems, methods, and devices for wireless communication that support a sensor sharing configuration. In a first aspect, a method of wireless communication includes receiving road congestion information associated with one or more regions. The method also includes receiving travel information associated with one or more vehicles. The method further includes transmitting an indicator of a sensor sharing configuration for the one or more vehicles. The sensor sharing configuration is based on the road congestion information and the travel information. Other aspects and features are also claimed and described.

### TECHNICAL FIELD

Aspects of the present disclosure relate generally to wireless communication systems, and more particularly, to a sensor sharing configuration, such as a sensor sharing configuration determined by a network for sensor sharing congestion control. Some features may enable and provide improved communications, including reduced communication overhead, improved network efficiency, improved resource and energy utilization, improved traffic safety messaging, a reduction in traffic accidents, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

A growing focus of research in wireless networks is the intersection of wireless communications and vehicular traffic. Along with advances for vehicles, there is a push for improvements to traffic control devices and other roadside devices. Typically, a server, such as a cloud server, is configured to receive information from different devices (e.g., an onboard unit (OBU) of a vehicle, a roadside unit (RSU), a traffic control device, a user equipment (UE), etc.) of a traffic system (e.g., a traffic safety system). To illustrate, the server may receive one or more messages, such as application-layer messages, including basic safety messages (BSMs), cooperative awareness messages (CAMs), collective perception messages (CPMs), sensor data sharing messages (SDSMs), other application-layer messages, or a combination thereof. In some implementations, a message received by the server may include sensor information or an indication of a detected object. If the server receives multiple messages that each report the same detected object, a network channel load (e.g., over-the-air (OTA) congestion) may be increased, which may degrade packet reception ratio (PRR) and object awareness ratio (OAR). To limit the server receiving multiple messages that each report the same detected object, the traffic system may implement one or more redundancy mitigation techniques (e.g., one or more sensor sharing mitigation techniques) to limit or reduce different devices of the traffic system sharing messages that that indicate the same detected object. A redundancy mitigation technique may be configured to enable a filtering of or a reduction of redundant or unnecessary updates of information associated with a sensed or detected object. For example, a redundancy mitigation technique may define one or more rules to omit a portion or a subset of perceived or detected objects (e.g., sensor data) that satisfy at least one rule. OBUs and RSUs are typically limited to congestion detection in their immediate vicinity. Although a vehicle may know a planned route of travel of the vehicle, the vehicle may be unable to determine or predict congestion, or how congestion may change, along the planned route. Accordingly, the vehicle may not be able to efficiently select an appropriate redundancy mitigation technique(s) as the vehicle travels along the planned route. By not selecting or using an appropriate redundancy mitigation technique(s), the traffic system may continue to suffer from an increased network channel load (e.g. increased OTA congestion).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of communication is performed by a network entity. The method includes receiving road congestion information associated with one or more regions. The method also includes receiving travel information associated with one or more vehicles. The method further includes transmitting an indicator of a sensor sharing configuration for the one or more vehicles. The sensor sharing configuration is based on the road congestion information and the travel information.

In an additional aspect of the disclosure, a network entity includes a memory storing processor-readable code and at least one processor coupled to the memory. The at least one processor is configured to execute the processor-readable code to cause the at least one processor to receive road congestion information associated with one or more regions, and receive travel information associated with one or more vehicles. The at least one processor is configured to execute the processor-readable code to cause the at least one processor to transmit or initiate transmission of an indicator of a sensor sharing configuration for the one or more vehicles. The sensor sharing configuration is based on the road congestion information and the travel information.

In an additional aspect of the disclosure, an apparatus for wireless communication includes means for receiving road congestion information associated with one or more regions. The apparatus also includes means for receiving travel information associated with one or more vehicles. The apparatus further includes means for transmitting an indicator of a sensor sharing configuration for the one or more vehicles. The sensor sharing configuration is based on the road congestion information and the travel information.

In an additional aspect of the disclosure, a non-transitory, computer-readable medium stores instructions that, when executed by a processor, cause the processor to perform operations. The operations include receiving road congestion information associated with one or more regions. The operations also include receiving travel information associated with one or more vehicles. The operations further include transmitting an indicator of a sensor sharing configuration for the one or more vehicles. The sensor sharing configuration is based on the road congestion information and the travel information.

In an additional aspect of the disclosure, an apparatus includes a communication interface configured receive road congestion information associated with one or more regions. The communication interface is further configured to receive travel information associated with one or more vehicles. The apparatus further includes at least one processor coupled to a memory storing processor-readable code. The at least one processor is configured to execute the processor-readable code to cause the at least one processor to generate an indicator of a sensor sharing configuration for the one or more vehicles. The sensor sharing configuration is based on the road congestion information and the travel information.

In an additional aspect of the disclosure, a method for wireless communication is performed by a network entity. The method includes transmitting road congestion information associated with a region. The method also includes receiving an indicator of a sensor sharing configuration for one or more vehicles. The sensor sharing configuration is based on the road congestion information and travel information associated with one or more vehicles. The method further includes transmitting a message that indicates the sensor sharing configuration to at least one vehicle.

In an additional aspect of the disclosure, a network entity includes a memory storing processor-readable code and at least one processor coupled to the memory. The at least one processor is configured to execute the processor-readable code to cause the at least one processor to transmit road congestion information associated with a region. The at least one processor is also configured to execute the processor-readable code to cause the at least one processor to receive an indicator of a sensor sharing configuration for one or more vehicles. The sensor sharing configuration is based on the road congestion information and travel information associated with one or more vehicles. The at least one processor is further configured to execute the processor-readable code to cause the at least one processor to transmit or initiate transmission of a message that indicates the sensor sharing configuration to at least one vehicle.

In an additional aspect of the disclosure, an apparatus for wireless communication includes means for transmitting road congestion information associated with a region. The apparatus also includes means for receiving an indicator of a sensor sharing configuration for one or more vehicles. The sensor sharing configuration is based on the road congestion information and travel information associated with one or more vehicles. The apparatus further includes means for transmitting a message that indicates the sensor sharing configuration to at least one vehicle.

In an additional aspect of the disclosure, a non-transitory, computer-readable medium stores instructions that, when executed by a processor, cause the processor to perform operations. The operations include transmitting road congestion information associated with a region. The operations also include receiving an indicator of a sensor sharing configuration for one or more vehicles. The sensor sharing configuration is based on the road congestion information and travel information associated with one or more vehicles. The operations further include transmitting a message that indicates the sensor sharing configuration to at least one vehicle.

In an additional aspect of the disclosure, an apparatus includes a communication interface configured to transmit road congestion information associated with a region. The communication interface is further configured to receive an indicator of a sensor sharing configuration for one or more vehicles. The sensor sharing configuration is based on the road congestion information and travel information associated with one or more vehicles. The apparatus further includes at least one processor coupled to a memory storing processor-readable code. The at least one processor is configured to execute the processor-readable code to cause the at least one processor to generate a message that indicates the sensor sharing configuration for at least one vehicle.

In an additional aspect of the disclosure, a method for communication is performed by a vehicle. The method includes transmitting travel information associated with the vehicle. The method also includes receiving a configuration message that indicates a sensor sharing configuration for the vehicle. The sensor sharing configuration is based on the travel information and road congestion information associated with a region. The method further includes transmitting, based on the sensor sharing configuration, a message that indicates a detected object.

In an additional aspect of the disclosure, a vehicle includes a memory storing processor-readable code and at least one processor coupled to the memory. The at least one processor is configured to execute the processor-readable code to cause the at least one processor to transmit travel information associated with the vehicle. The at least one processor is also configured to execute the processor-readable code to cause the at least one processor to receive a configuration message that indicates a sensor sharing configuration for the vehicle. The sensor sharing configuration is based on the travel information and road congestion information associated with a region. The at least one processor is further configured to execute the processor-readable code to cause the at least one processor to transmit, based on the sensor sharing configuration, a message that indicates a detected object.

In an additional aspect of the disclosure, an apparatus for communication includes means for transmitting travel information associated with a vehicle. The apparatus also includes means for receiving a configuration message that indicates a sensor sharing configuration for the vehicle. The sensor sharing configuration is based on the travel information and road congestion information associated with a region. The apparatus further includes means for transmitting, based on the sensor sharing configuration, a message that indicates a detected object.

In an additional aspect of the disclosure, a non-transitory, computer-readable medium stores instructions that, when executed by a processor, cause the processor to perform operations. The operations include transmitting travel information associated with a vehicle. The operations also include receiving a configuration message that indicates a sensor sharing configuration for the vehicle. The sensor sharing configuration is based on the travel information and road congestion information associated with a region. The operations further include transmitting, based on the sensor sharing configuration, a message that indicates a detected object.

In an additional aspect of the disclosure, an apparatus includes a communication interface configured transmit travel information associated with the vehicle. The communication interface is also configured to receive a configuration message that indicates a sensor sharing configuration for the vehicle. The sensor sharing configuration is based on the travel information and road congestion information associated with a region. The apparatus further includes at least one processor coupled to a memory storing processor-readable code. The at least one processor is configured to execute the processor-readable code to cause the at least one processor to generate, based on the sensor sharing configuration, a message that indicates a detected object.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports a sensor sharing configuration according to one or more aspects.

FIG. 5 is block diagram illustrating an example format of an information element that supports a sensor sharing configuration according to one or more aspects.

FIG. 6 is a flow diagram illustrating an example process that supports a sensor sharing configuration according to one or more aspects.

FIG. 7 is a flow diagram illustrating an example process that supports a sensor sharing configuration according to one or more aspects.

FIG. 8 is a flow diagram illustrating an example process that supports a sensor sharing configuration according to one or more aspects.

FIG. 9 is a flow diagram illustrating an example process that supports a sensor sharing configuration according to one or more aspects.

FIG. 10 is a perspective view of a motor vehicle with a driver monitoring system according to one or more aspects.

FIG. 11 is a block diagram of an example network entity that supports a sensor sharing configuration according to one or more aspects.

FIG. 12 is a block diagram of an example server that supports a sensor sharing configuration according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support a sensor sharing configuration. For example, a network of a traffic system may be configured to determine, based on travel information of a vehicle, a sensor sharing configuration (e.g., a redundancy mitigation technique) to be used by the vehicle. To illustrate, a server (e.g., a cloud server) of the traffic system may be configured to receive travel information associated with one or more vehicles. For example, the server may receive a basic safety message (BSM), a cooperative awareness message (CAM), a collective perception message (CPM), a sensor data sharing message (SDSM), or another message that includes or indicates the travel information of one or more vehicles. Additionally, the server may determine a congestion, such as a traffic congestion or over-the-air (OTA) congestion, of one or more areas or regions based on congestion information received from one or more vehicles, one or more network entities, one or more user equipments (UEs), one or more roadside units (RSUs), one or more base stations, or a combination thereof. In some implementations, the congestion information includes one or more channel busy ratio (CBR) measurements included in or indicated by one or more BSMs, one or more CAMs, one or more other messages, or a combination thereof. Additionally, or alternatively, the server may determine the congestion based on other information, such as a time of day (e.g., rush hour), an emergency or hazardous situation, an event (e.g., a parade, a sporting event, a concert), historical travel data of a vehicle, or a combination thereof, as illustrative, non-limiting examples. Based on the travel information of one or more vehicles and the determined congestion, the server may predict a future location of the one or more vehicles and determine a sensor sharing configuration for the one or more vehicles, such as a mitigation technique or rule, a parameter for the mitigation technique or rule, or a combination thereof. The server may transmit an indicator that indicates the sensor sharing configuration to the one or more vehicles. For example, the sensor sharing configuration may be communicated to the one or more vehicles in a dedicated fashion (e.g., application-layer or signaling over Uu or PC5, PC5-S) or in a common fashion (e.g., Uu-based system information block (SIB) broadcast or PC5-based distance signaling).

Particular implementations of the subject matter described in this disclosure may be implemented to realize one or more of the following potential advantages or benefits. In some aspects, the present disclosure provides techniques for supporting a sensor sharing configuration (e.g., a redundancy mitigation technique). For example, the techniques may enable a network (e.g., a server) to proactively determine a sensor sharing configuration for a vehicle based on travel information of the vehicle and a determined congestion. By proactively determining the sensor sharing configuration for a region that the vehicle has not yet traveled to, the network may enable more efficient spectrum utilization for one or more devices included in the traffic system as compared to relying on the vehicle to select the sensor sharing configuration. For example, the traffic system may experience improved communications, including reduced network channel load (e.g. reduced OTA congestion), improved network efficiency, improved resource and energy utilization, improved traffic safety messaging, a reduction in traffic accidents, or a combination thereof.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1 M nodes/km2), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 millisecond (ms)), and users with wide ranges of mobility or lack thereof; and (3) with enhanced mobile broadband including extreme high capacity (e.g., ~10 Tbps/km2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

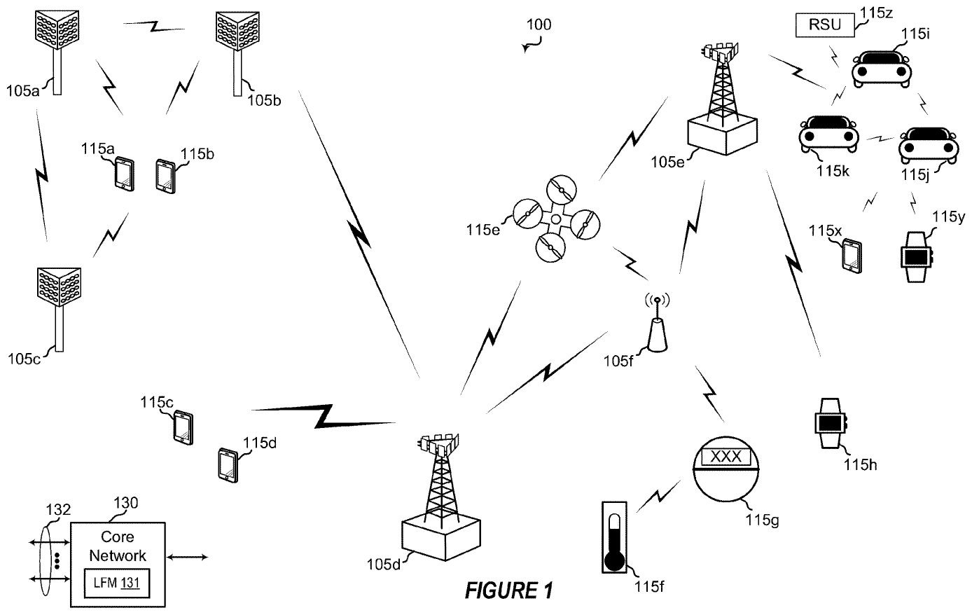

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e. Additionally, V2V mesh network may include or correspond to a vehicle-to-everything (V2X) network between UEs 115i-115k and one or more other devices, such as UEs 115x, 115y, or UE 115z (e.g., a roadside unit (RSU)).

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a management function, such as a Location Management Function (LMF) 131, a Sensing Management Function (SnMF), or an Access and Mobility Management Function (AMF), which is an entity in the 5G Core Network (5GC) supporting various functionality, such as managing support for different location services for one or more UEs. The SnMF may be configured to manage support for sensing operations for one or more sensing operations or sensing services for one or more devices, such as one or more UEs 115, one or more base stations 105, one or more TRPs, or a combination thereof. For example the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. The LMF 131 may include one or more servers, such as multiple distributed servers. Base stations 105 may forward location messages to the LMF 131 and may communicate with the LMF 131 via a NR Positioning Protocol A (NRPPa). The LMF 131 is configured to control the positioning parameters for UEs 115 and the LMF 131 can provide information to the base stations 105 and UE 115 so that action can be taken at UE 115. In some implementations, UE 115 and base station 105 are configured to communicate with the LMF 131 via the AMF.

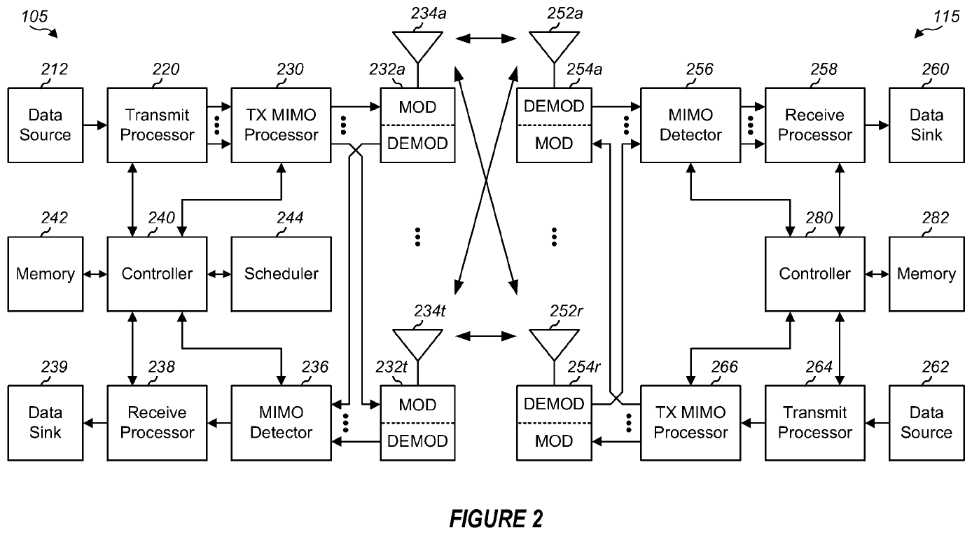

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

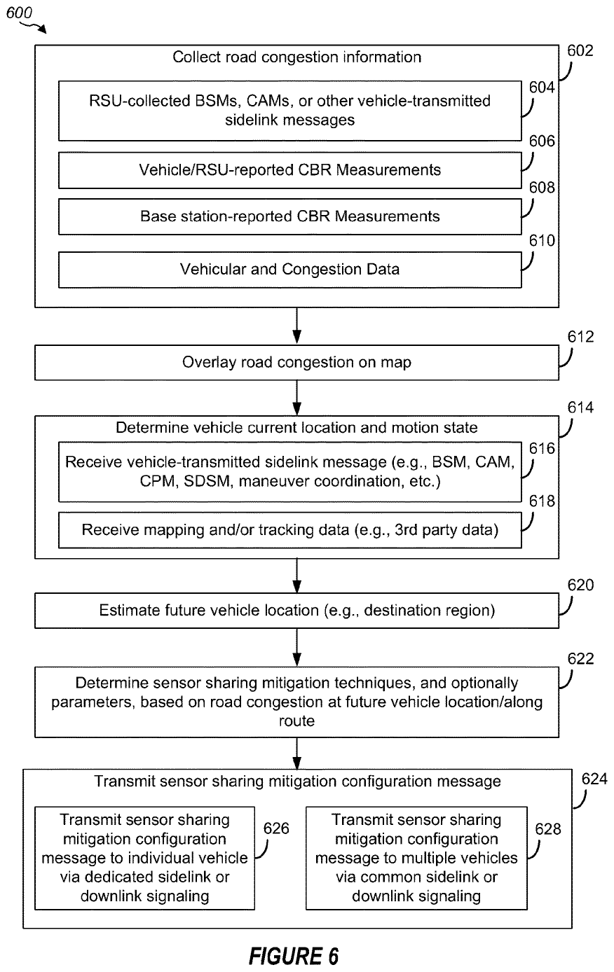

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in or described with reference to FIGS. 6-9, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

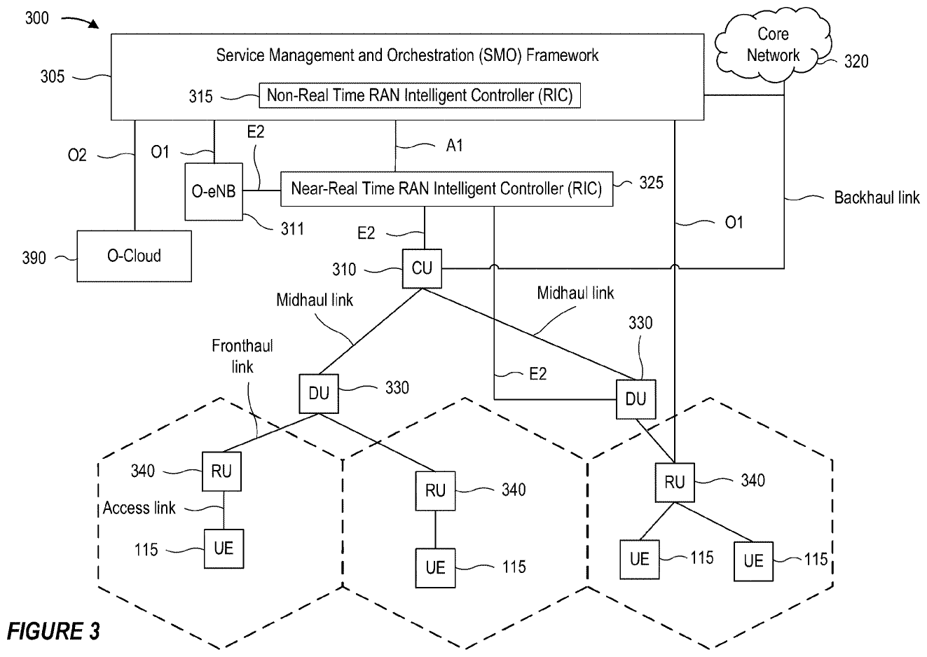

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RUs 340 can be implemented to handle over the air (OTA) communication with one or more UEs 115. In some implementations, real-time and non-real-time aspects of control and user plane communication with the RUs 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, a server, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

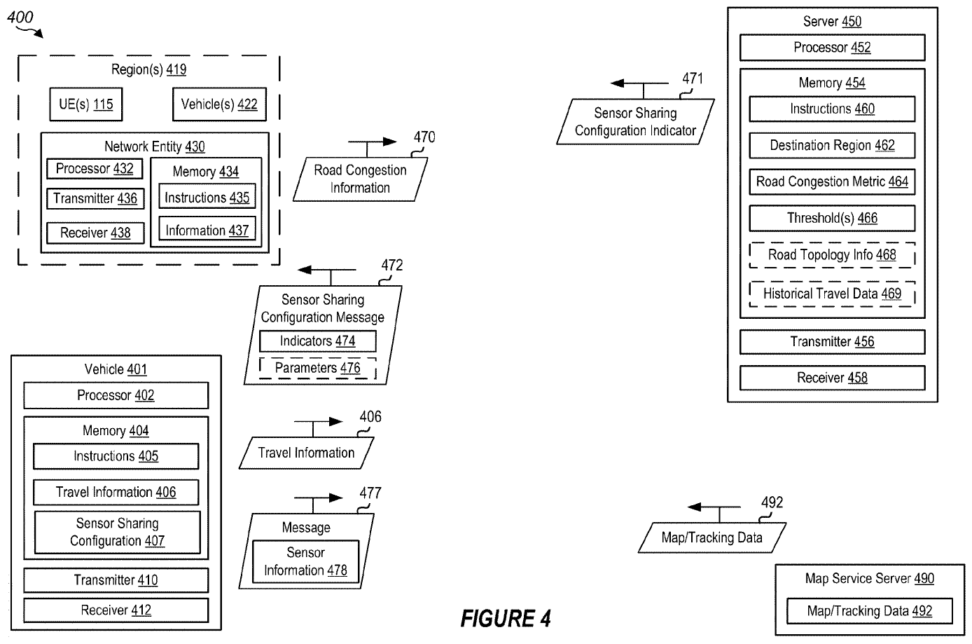

FIG. 4 is a block diagram of an example wireless communications system 400 that supports a sensor sharing configuration according to one or more aspects. In some examples, wireless communications system 400 may implement aspects of wireless network 100. Wireless communications system 400 includes UE 115, vehicle 401, vehicle 422, network entity 430, server 450, and map service server 490. In some implementations, vehicle 401 or 422 may include or correspond to UEs 115e, 115i, 115j, 115k of FIG. 1. In some implementations, vehicle 401, vehicle 422, and UE 115, or a combination thereof, may be individually or collectively referred to as a vehicle system. In some implementations, UE 115 may include or correspond to a device of a pedestrian (e.g., a VRU). For example, the device of the pedestrian may include or correspond to UE 115a, 115b, 115c, 115d, 114h, 115x, or 115y, as illustrative, non-limiting examples. Network entity 430 may include one or more base station (e.g., 105), a road side unit (RSU), a traffic control device, or a combination thereof.

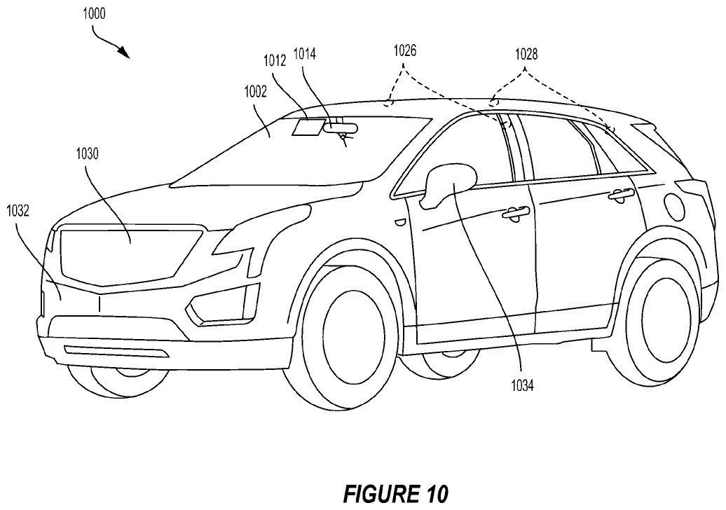

Although one UE 115, two vehicles 401 and 422, and one network entity 430 are illustrated in FIG. 4, in some other implementations, wireless communications system 400 may generally include multiple UEs 115, one or more vehicles 401, 422, multiple network entities 430, or a combination thereof. It is noted that vehicle 401 and 422 may also be referred to as a mobile entity—e.g., vehicle 401 is a first mobile entity and vehicle 422 is a second mobile entity. Vehicle 401 or vehicle 422 may include or correspond to a vehicle as described further herein at least with reference to FIG. 10. In some implementations, network entity 430 and server 450 may be individually or collectively referred to as a network, a network device, or a network system (e.g., a safety system or a traffic system).

In some implementations, wireless communications system 400 includes a vehicle to everything (V2X) wireless communication system. V2X is a communication system in which information is passed between a vehicle and other entities within the wireless communication network that provides the V2X services. The V2X services may include services for Vehicle-to-Vehicle (V2V), Vehicle-to-Pedestrian (V2P), Vehicle-to-Infrastructure (V2I), and Vehicle-to-Network (V2N). One or more V2X standards aim to develop or support an Advanced Driver Assistance System (ADAS), which assist a driver with critical decisions, such as lane changes, speed changes, overtaking speeds, etc. Low latency communications may be used in V2X and, are therefore suitable for precise positioning. For example, positioning techniques, such as time of arrival (TOA), time difference of arrival (TDOA) or observed time difference of arrival (OTDOA), or any other positioning technique, may be enhanced using assistance from V2X.

In some implementations, there may be at least two modes of operation for V2X services, as defined in Third Generation Partnership Project (3GPP) TS 23.285. One mode of operation uses direct wireless communications between V2X entities when the V2X entities are within range of each other. The other mode of operation uses network based wireless communication between entities. The two modes of operation may be combined or other modes of operation may be used if desired.

In some implementations, the wireless communication of a V2X wireless communication system may be over Proximity-based Services (ProSe) Direction Communication (PC5) reference point as defined in 3GPP TS 23.303, and may use wireless communications under Institute of Electrical and Electronics Engineers (IEEE) 1609, Wireless Access in Vehicular Environments (WAVE), Intelligent Transport Systems (ITS), and IEEE 802.11p, on the ITS band of 5.9 GHZ, or other wireless connections directly between entities. Such wireless communications may include or be referred to as sidelink communications. In some implementations, one or more communications that occur in wireless communication system 400 may be compliant with ETSI TR 103 562 V2.1.1 (2019 December).

In some implementations, wireless communications system 400 is associated with a one or more regions 419 (hereinafter referred to collectively as “region 419”). Region 419 may include or also be referred to as a geographic area, a zone, or a communication service area, as illustrative, non-limiting examples. Region 419 may include one or more roads, one or more intersections, or a combination thereof.

In some implementations, UE 115, vehicle 401, vehicle 422, network entity 430, or a combination thereof may be positioned within region 419. Although each of UE 115, vehicle 422, and network entity 430 is described and shown as being positioned within region 419, in other implementations, one or more of UE 115, vehicle 422, or network entity 430 may be positioned outside of region 419. Additionally, or alternatively, UE 115, vehicle 401, or vehicle 422 may be traveling towards or positioned within region 419. In some implementations, UE 115, vehicle 401, vehicle 422, or a combination thereof, are mobile devices. Network entity 430 may include a base station, such as base station 105, an access point, a roadside unit (RSU), another UE or vehicle, or part of a core network, such as core network 130. Network entity 430 may be stationary or mobile. In some implementations, network entity 430 includes or is integrated with a traffic control device, such as a traffic light, an on-ramp access control device, a digital road sign, or another type of traffic control device. In some other implementations, network entity 430 is communicatively coupled to a traffic control device and communicates with the traffic control device to control the traffic control device (e.g., via providing instructions), to provide network access to the traffic control device, or a combination thereof. Server 450 may include a server, base station 105, core network 130, or other device or system. For example, server 450 may include a car 2 cloud (C2C) server. In some implementations, server 450 is or includes LMF 131.

In some implementations, UE 115, vehicle 401, vehicle 422, or network entity 430 is configured to communicate with another of UE 115, vehicle 401, vehicle 422, or network entity 430 using a sidelink (SL) link/interface (e.g., using sidelink communication). Additionally, or alternatively, UE 115, vehicle 401, or vehicle 422, or a combination thereof, is configured to communicate with network entity 430 using a SL link/interface (e.g., using sidelink communication) or a Uu link/interface (e.g., using Uu communication). Server 450 may be in communication with (e.g., communicatively coupled to) UE 115, vehicle 401 or 422, or network entity 430 via a cellular network. Server 450 may be configured to be aware of a situational awareness (e.g., a position, a heading, a speed, etc.) of UE 115 or vehicle 401 or 422 based on information included in a safety message, such as a basic safety message (BSM) message (for vehicle 401 or 422), a personal safety message (PSM) message (for UE 115), a collective perception message (CPM), or a combination thereof, as illustrative, non-limiting examples. Additionally, or alternatively, server 450 may be aware of the maps of or associated with region 419, such as a map that indicates a nature of roads, intersections, stop signs, traffic lights in a geographic area, or other information, as illustrative, non-limiting examples. For example, a map or map data associated with region 419 may include or correspond to map or tracking data 492, as described further herein.

In some implementations, a BSM may include or indicate information (e.g., BSM information), such as position, motion, control, size, an event, or a combination thereof. The position may include or indicate latitude, longitude, elevation, positional accuracy. The motion may include or indicate a transmission setting, a speed, a heading, a steering wheel angle, an acceleration (e.g., a longitudinal acceleration, a lateral acceleration, a vertical acceleration, a yaw rate, or a combination thereof), or a combination thereof. The control may include or indicate a brake system status, such as braking or not braking, as illustrative, non-limiting examples. The size may include or indicate a vehicle size, such a weight, a length, a width, a height, a maximum number of passengers, or a combination thereof, as illustrative, non-limiting examples. The event may include, indicate, or be associated with hazard lights, a stop line violation, an automatic braking system (ABS), traction control, stability control, hazardous materials, emergency response, hard braking, lights changed, wipers changed, a flat tire, a disabled vehicle, an air bag deployment, or a combination thereof, as illustrative, non-limiting examples. In some implementations, the CPM may include or indicate information about a detected object, an onboard sensor, or a combination thereof. The CPM may include, correspond to, or be defined by an ETSI ITS Intelligent Transport System (ITS) standard. As an illustrative, non-limiting example, the CPM may include or indicate an object identifier (ID), an object description, a local sensor perception, a neighboring vehicle perception, an RSU perception, or a combination thereof.

UE 115 may include a device, such as a mobile device or a stationary device. In some implementations, UE 115 is a device that is configured to communicate with vehicle 401 or 422, network entity 430, or both. In some implementations, UE 115 is configured to control or partially control operations of vehicle 401 or 422. Alternatively, UE 115 may be associated with a pedestrian or another type of device other than a vehicle. UE 115 may include a variety of components (such as structural, hardware components) used for carrying out one or more functions described herein. For example, these components may include one or more processors, one or more memory devices, one or more transmitters, one or more receivers, and optionally an antenna array, as described above with reference to vehicle 401. In some implementations, UE 115 may include an interface (e.g., a communication interface) that includes a transmitter, a receiver, or a combination thereof. The one or more processors may be configured to execute instructions stored in the one or more memory devices to perform the operations described herein. In some implementations, the one or more processors include or correspond to one or more of receive processor 258, transmit processor 264, and controller 280 of FIG. 2, and the one or more memory devices include or correspond to memory 282 of FIG. 2.

UE 115 may include one or more components as described herein with reference to UE 115 of FIGS. 1-3. In some implementations, UE 115 is a 5G-capable UE, a 6G-capable UE, or a combination thereof.

Vehicle 401 may include a device, such as a mobile device or a vehicle. For example, vehicle 401 may include or correspond to UEs 115e, 115i, 115j, 115k of FIG. 1. As illustrative examples, vehicle 401 may include a self-driving car or assisted-driving car, a UAV or drone aircraft, such as drone 115e of FIG. 1, or any other type of autonomous or semi-autonomous land craft, watercraft, aircraft, or combination thereof. Although one or more examples may be described herein in the context of an autonomous or semi-autonomous car, such examples are illustrative and are not intended to limit vehicle 401 to any particular type of vehicle. Additionally or alternatively, although referred to herein as being a vehicle, the components of vehicle 401 may be included in or integrated within an onboard unit (OBU) of a vehicle. Vehicle 401 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 410 (hereinafter referred to collectively as “transmitter 410”), and one or more receivers 412 (hereinafter referred to collectively as “receiver 412”). In some implementations, vehicle 401 may include an interface (e.g., a communication interface) that includes transmitter 410, receiver 412, or a combination thereof. Processor 402 may be configured to execute instructions 405 stored in memory 404 to perform the operations described herein. In some implementations, processor 402 includes or corresponds to one or more of receive processor 258, transmit processor 264, and controller 280 of FIG. 2, and memory 404 includes or corresponds to memory 282 of FIG. 2.

Memory 404 includes or is configured to store instructions 405, travel information 406, and one or more sensor sharing configurations 407 (hereinafter referred to collectively as “sensor sharing configuration 407”). Travel information 406 may include or indicate travel of or for vehicle 401. For example, travel information 406 may include or indicate a position of vehicle 401, a speed of vehicle 401, a heading of vehicle 401, a direction of travel of vehicle 401, a route of travel of vehicle 401, a start location of vehicle 401, an end location of vehicle 401, an estimated time of arrival of vehicle 401, or a combination thereof. Additionally, or alternatively, travel information 406 may include or indicate historical travel information of vehicle 401.

Sensor sharing configuration 407 may include or indicate a one or more sensor sharing mitigation techniques (e.g., one or more redundancy mitigation techniques) to be performed at the one or more vehicles. Such sensor sharing mitigation techniques may be applied by vehicle 401 to reduce the number of sensor related messaging that is communicated by vehicle 401, as further described herein. The one or more sensor sharing mitigation techniques may include or indicate a frequency-based mitigation technique, a distance-based mitigation technique, a dynamics-based mitigation technique, a confidence-based mitigation technique, an entropy-based mitigation technique, an object self-announcement-based mitigation technique, or a combination thereof. Additionally, or alternatively, sensor sharing configuration 407 may include or indicate, for at least one sensor sharing mitigation technique of the one or more sensor sharing mitigation techniques, one or more parameters. The one or more parameters may include or indicate a temporal window, detection instances, a threshold distance, a threshold speed, another threshold or parameter, or a combination thereof. A sensor sharing mitigation technique may be configured to enable a filtering of or a reduction of redundant or unnecessary frequent updates of information included in a collective perception message, such as information associated with a sensed or detected object For example, a sensor sharing mitigation technique may be configured to enable a filtering of or a reduction of redundant or unnecessary frequent updates of a sensed or detected object by defining one or more rules to omit a portion of or a subset of perceived or detected objects (e.g., sensor data) that satisfy at least one rule.

In some implementations, sensor sharing configuration 407 or the one or more sensor sharing mitigation techniques may at least in part be defined by a standard, such as ETSI TR 103 562 V2.1.1 (2019 December). For example, a sensor sharing mitigation technique may include or be defined as one or more rules of a standard. To illustrate, the frequency-based mitigation technique may include or be defined by a frequency-based rule (e.g., Section 4.5.2 of ETSI TR 103 562 V2.1.1 (2019 December)), the distance-based mitigation technique may include or be defined by a distance-based rule (e.g., Section 4.5.7 of ETSI TR 103 562 V2.1.1 (2019 December)), the dynamics-based mitigation technique may include or be defined by a dynamics-based rule (e.g., Section 4.5.3 of ETSI TR 103 562 V2.1.1 (2019 December)), the confidence-based mitigation technique may include or be defined by a confidence-based rule (e.g., Section 4.5.4 of ETSI TR 103 562 V2.1.1 (2019 December)), the entropy-based mitigation technique may include or be defined by an entropy-based rule (e.g., Section 4.5.5 of ETSI TR 103 562 V2.1.1 (2019 December)), or the object self-announcement-based mitigation technique may include or be defined by an object self-announcement rule (e.g., Section 4.5.6 of ETSI TR 103 562 V2.1.1 (2019 December)).

In some implementations, at least one sensor sharing mitigation technique of the one or more sensor sharing mitigation techniques may include or be associated with a parameter. For example, the frequency-based mitigation technique (e.g., the frequency-base rule) may include or be associated with a temporal window (W_{Redundancy}), detection instances (N_{Redundancy}), or a combination thereof. As another example, the distance-based mitigation technique (e.g., the distance-based rule) may include or be associated with a temporal window (W_{Redundancy}), threshold distance (R_{Redundancy}), or a combination thereof. As a further example, the dynamics-based mitigation technique (e.g., the dynamics-based rule) may include or be associated with a threshold distance (P_{Redundancy}), threshold speed (S_{Redundancy}), or a combination thereof. As another example, the confidence-based mitigation technique (e.g., the confidence-based rule) may include or be associated with a temporal window (W_{Redundancy}). As an additional example, the entropy-based mitigation technique (e.g., the entropy-based rule) may include or be associated with a threshold (E_{Redundancy}).

In some implementations, the frequency-based mitigation technique (e.g., the frequency-base rule) may be configured to omit reporting of a detected object if the detected object appeared within a temporal window W_{Redundancy} more than N_{Redundancy} times (e.g., in more than N_{Redundancy} received SDSMs or CPMs). For a larger N_{Redundancy} threshold, information on the same object is transmitted more frequently and may cause increased congestion. For a larger W_{Redundancy} temporal window threshold, information on the same object is transmitted less frequently and may cause decreased congestion.

In some implementations, the distance-based mitigation technique (e.g., the distance-based rule) may be configured to omit reporting of a detected object if another detected object (e.g., detected by another vehicle) is included in a received SDSM or CPM within a temporal window W_{Redundancy} and vehicle 401 is less than a threshold distance (R_{Redundancy}) from another vehicle sending the SDSM or CPM. For a larger R_{Redundancy} distance threshold, information on the same object is transmitted less frequently and may cause decreased congestion. For a larger W_{Redundancy} temporal window threshold, information on the same object is transmitted less frequently and may cause decreased congestion.

In some implementations, the dynamics-based mitigation technique (e.g., the dynamics-based rule) may be configured to omit reporting of a detected object if a detected object position changes from an SDSM-reported or CPM-reported position less than threshold distance (e.g., P_{Redundancy}=4 m), and a detected object speed changes from an SDSM-reported speed less than a threshold speed (e.g., S_{Redundancy}=0.5 m/s). The dynamics-based redundancy mitigation technique may be configured such that a detected object changing speed will be reported more frequently than a detected object moving at constant speed. If the speed of a detected object is constant, it may be reported periodically. Similarly, a detected object that moves larger distances will be reported more frequently than a detected object that moves smaller distances.

In some implementations, the confidence-based mitigation technique (e.g., the confidence-based rule) may be configured to omit reporting of an object if a historical SDSM or CPM includes information about the same object and if the maximum confidence of the object information in these historical SDSMs or CPMs is higher than the confidence of the transmitting station's (e.g., vehicle 401) local perception of this object. The confidence-based mitigation technique may enable the object information with higher confidence to be prioritized even under heavy network channel load.

In some implementations, the entropy-based mitigation technique (e.g., the entropy-based rule) may be configured to omit reporting of an object if a neighboring intelligent transport systems-station (ITS-S) is expected to perceive the object and if, for multiple or all the neighboring ITS-Ss, the relative entropy of that locally perceived object information is lower than a threshold E_{Redundancy}. The entropy-based rule may mitigate the impact of the potential loss of CPMs or SDSMs by taking into account the distance between ITS-Ss when estimating a set of historical CPMs or SDSMs that each neighboring ITS-S is expected to have received. Additionally, or alternatively, the entropy-based rule may consider quality and freshness of the object information in calculating the anticipated knowledge of neighboring ITS-Ss. In some implementations, the entropy-based rule may mitigate the risk of incorrectly omitting object information from CPMs or SDSMs.

In some implementations, the object self-announcement-based mitigation technique (e.g., the object self-announcement rule) may be configured to omit reporting of a perceived object if the object itself is V2X-capable (e.g., an ITS station) which transmits its own V2X messages (e.g., BSMs, SDSMs). The object self-announcement rule may provide a straight-forward mechanism to identify and eliminate V2X-capable entities (RSUs, OBUs) from being reported in an SDSM, which may cause a resulting message size decrease with increasing market penetration rate, as other V2X-capable vehicles or other traffic participants are no longer included in a SDSM.

Transmitter 410 is configured to transmit reference signals, control information and data to one or more other devices, and receiver 412 is configured to receive references signals, synchronization signals, control information and data from one or more other devices. For example, transmitter 410 may transmit signaling, control information and data to, and receiver 412 may receive signaling, control information and data from, network entity 430, UE 115, or another vehicle 401. In some implementations, transmitter 410 and receiver 412 may be integrated in one or more transceivers. Additionally, or alternatively, transmitter 410 or receiver 412 may include or correspond to one or more components of UE 115 described with reference to FIG. 2.

In some implementations, vehicle 401 may include one or more antenna arrays. The one or more antenna arrays may be coupled to transmitter 410, receiver 412, or a communication interface. An antenna array may include multiple antenna elements configured to perform wireless communications with other devices, such as with network entity 430 or UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of vehicle 401. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Vehicle 422 may include or correspond to vehicle 401. For example, vehicle 422 may include one or more components as described with reference to vehicle 401. Additionally, or alternatively, vehicle 422 may be configured to perform one or more operations as described with reference to vehicle 401. It is also noted that vehicle 401 may be configured to also perform one or more operations as described with reference to vehicle 422.

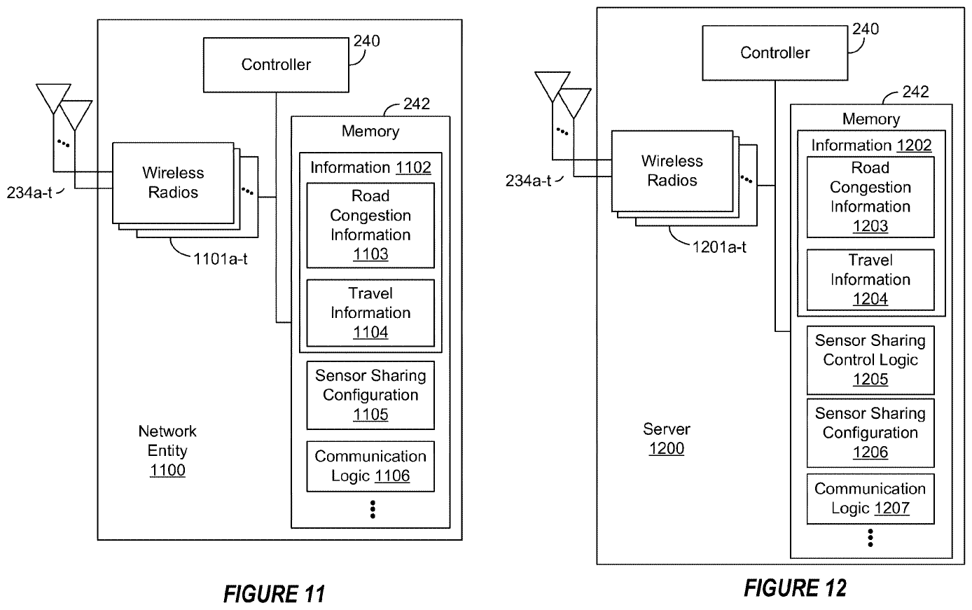

Vehicle 401 or 422 may include one or more components as described herein with reference to UE 115, the vehicle of FIG. 10, or the network entity of FIG. 11. In some implementations, vehicle 401 or 422 is a 5G-capable vehicle, a 6G-capable vehicle, or a combination thereof.

Network entity 430 may include a device, such as a base station, a roadside unit, a node, or another UE. Network entity 430 may be a mobile device or a stationary device. Network entity 430 may include a variety of components (such as structural, hardware components) used for carrying out one or more functions described herein. For example, these components may include one or more processors 432 (hereinafter referred to collectively as “processor 432”) and one or more memory devices 434 (hereinafter referred to collectively as “memory 434”). In some implementations, network entity 430 may include an interface (e.g., a communication interface) that includes transmitter 436, receiver 438, or a combination thereof. Processor 432 may be configured to execute instructions 435 stored in memory 434 to perform the operations described herein. In some implementations, processor 432 includes or corresponds to one or more of receive processor 238, transmit processor 220, and controller 240, and memory 434 includes or corresponds to memory 242. In some other implementations, processor 432 includes or corresponds to one or more of receive processor 258, transmit processor 264, and controller 280 of FIG. 2, and memory 434 includes or corresponds to memory 282 of FIG. 2.

Memory 434 includes or is configured to store instructions 435 and information 437. Information 437 may include or correspond to travel information 406, sensor sharing configuration 407, or a combination thereof. Additionally, or alternatively, information 437 may include congestion information. The congestion information may be associated with one or more regions, such as region 419. The congestion information may include or indicate road congestion, traffic congestion, communication congestion (e.g., over-the-air (OTA) congestion), or a combination thereof. For example, the congestion information, such as road congestion information 470, may include or one or more CBR measurements reported by a vehicle, an RSU, or a combination thereof, one or more CBR measurements reported by one or more base stations, traffic camera data, lane metering data, temporal congestion data, or a combination thereof.

Network entity 430 includes one or more transmitters 436 (hereinafter referred to collectively as “transmitter 436”), and one or more receivers 438 (hereinafter referred to collectively as “receiver 438”). Transmitter 436 is configured to transmit reference signals, control information and data to one or more other devices, and receiver 438 is configured to receive references signals, synchronization signals, control information and data from one or more other devices. For example, transmitter 436 may transmit signaling, control information and data to, and receiver 438 may receive signaling, control information and data from, base station 105, UE 115, vehicle 401 or 422, another network entity 430, or server 450. In some implementations, transmitter 436 and receiver 438 may be integrated in one or more transceivers. Additionally, or alternatively, transmitter 436 or receiver 438 may include or correspond to one or more components of base station 105 described with reference to FIG. 2 or UE 115 described with reference to FIG. 2.

In some implementations, network entity 430 may include one or more antenna arrays. The one or more antenna arrays may be coupled to transmitter 436, receiver 438, or a communication interface. The antenna array may include multiple antenna elements configured to perform wireless communications with other devices, such as with UE 115, vehicle 401, vehicle 422, server 450, or base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of network entity 430. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Network entity 430 may include one or more components as described herein with reference to UE 115 or base station 105. In some implementations, network entity 430 is a 5G-capable network entity, a 6G-capable network entity, or a combination thereof.

Server 450 may include a variety of components (such as structural, hardware components) used for carrying out one or more functions described herein. For example, these components may include one or more processors 452 (hereinafter referred to collectively as “processor 452”) and one or more memory devices 454 (hereinafter referred to collectively as “memory 454”). In some implementations, server 450 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store instructions 460, destination region 462, road congestion metric 464, one or more thresholds 466 (hereinafter referred to collectively as “threshold 466”), road topology information 468, historical travel data 469, or a combination thereof. Destination region 462 may include or indicate a region in which a destination (e.g., an end location) of a vehicle, such as vehicle 401, is located. Additionally or alternatively, destination region 462 may include or indicate one or more intervening or intermediate regions between a current region (e.g., a region in which a vehicle is currently located) and the destination region. Regions may be identified based on map information (e.g., based on geographic locations or features or known designations, such as counties, cities, towns, states, countries, provinces, territories, etc.), based on predefined designations, based on coverage areas (e.g., cells of wireless communications system 400), using other techniques, or a combination thereof. In some particular implementations, destination region 462, and optionally intervening or intermediate region(s), may be identified from information provided by the respective vehicles, by mapping data from 3rd-party party mapping applications (e.g., supported by map service server 490), or a combination thereof. Destination region 462 may indicate a particular region of one or more identified regions in which one or more vehicles (e.g., vehicle 401) are expected to be located at a future time (e.g., an expected arrival time for a final destination region or another time for an intervening or intermediate region).

Road congestion metric 464 is a metric indicating detected, measured, or estimated road congestion within destination region 462. For example, road congestion metric 464 may indicate road congestion, traffic congestion, communication congestion (e.g., OTA congestion), or a combination thereof, within destination region 462, which is beyond the detection range of the one or more vehicles expected to be located within destination region 462 at a future time. Road congestion metric 464 may be determined based on congestion information received from vehicles, UEs, RSUs, base stations, traffic cameras, lane meters, other traffic sensors, or a combination thereof, associated with destination region 462. As illustrative, non-limiting examples, road congestion metric 464 may include a quantity of vehicles located within destination region 462, trends in the quantity of vehicles located within destination region 462, counts of safety messages being communicated within destination region 462, channel metrics associated with destination region 462, other metrics, or a combination thereof. Threshold 466 may include or indicate one or more values, one or more ranges, or a combination thereof. Threshold 466 may be associated with a time, a duration, a heading, a distance, or a combination thereof. Additionally or alternatively, threshold 466 may be associated with a number of vehicles within a region, a rate of change of the number of vehicles within the region, a number of safety messages, a signal strength or other channel metric, or a combination thereof.

Road topology information 468 includes or indicates topological or other geographic features and information associated with one or more roads for which vehicles monitored by server 450 may travel. For example, road topology information 468 may indicate the location, arrangement, and the like, of one or more roads, as well as other related information, such as intersections between roads, distances of roads, locations of other elements (e.g., stop signs, traffic lights, toll collections, etc.), or a combination thereof. In some implementations, road topology information 468 may be used to determine a position of a vehicle on a road (e.g., based on geographic coordinates or other position information), one or more destination regions of a vehicle, an anticipated path of a vehicle, or a combination thereof. Historical travel data 469 may indicate historical travel patterns of one or more vehicles. Historical travel data 469 may include or indicate historic location or positioning data associated with one or more vehicles, historical speed data associated with the one or more vehicles, historical directions associated with the one or more vehicles, historical headings associated with the one or more vehicles, historical travel paths associated with the one or more vehicles, historical travel times associated with the one or more vehicles, other information, or a combination thereof. Historical travel data 469 may indicate or be analyzed to determine trends or patterns in historical travel associated with one or more vehicles, and such patterns may be periodic with varying frequency or dependent on temporal conditions (e.g., time of the day, day of the week, month of the year, etc.). For example, historical travel data 469 may indicate that a vehicle typically travels from a first location (e.g., home) to a second location (e.g., work) during mornings, remains stationary for multiple hours, and then travels from the second location to the first location during evenings of multiple days of the week. During other days (e.g., weekends), historical travel data 469 may indicate other patterns (e.g., frequent travel from the first location to other locations, such as shopping centers or entertainment locations) or may not indicate discernable patterns.

Server 450 includes one or more transmitters 456 (hereinafter referred to collectively as “transmitter 456”), and one or more receivers 458 (hereinafter referred to collectively as “receiver 458”). Transmitter 456 is configured to transmit reference signals, control information and data to one or more other devices, and receiver 458 is configured to receive references signals, synchronization signals, control information and data from one or more other devices. For example, transmitter 456 may transmit signaling, control information and data to, and receiver 458 may receive signaling, control information and data from, base station 105, UE 115, vehicle 401 or 422, network entity 430, or server 450. In some implementations, transmitter 456 and receiver 458 may be integrated in one or more transceivers. Additionally, or alternatively, transmitter 456 or receiver 458 may include or correspond to one or more components of base station 105 described with reference to FIG. 2 or UE 115 described with reference to FIG. 2.

Map service server 490 may include or correspond to server 450. For example, map service server 490 may include one or more components as described with reference to server 450. Additionally, or alternatively, map service server 490 may be configured to perform one or more operations as described with reference to server 450. It is also noted that server 450 may be configured to also perform one or more operations as described with reference to map service server 490.

Map service server 490 may include map data or tracking data that is associated with one or more vehicles, such as map or tracking data 492 that is associated with vehicle 401. The map data or tracking data may be generated, determined, or maintained, as part of a map or navigation service provided by map service server 490. For example, vehicles that participate in a service provided by map service server 490 may provide respective location information and destination information, and map service server 490 may send map data, navigation or direction data, or a combination thereof, the vehicles in order for the vehicles to display or provide maps between respective locations and destinations, driving or navigation directions, or both. As an illustrative example, map or tracking data 492 may include or indicate a map between a current (or starting) location of vehicle 401 and a destination of vehicle 401, navigation information (e.g., directions, travel times, etc.) associated with travel of vehicle 401 along roads within the map, tracking data to enable vehicle 401 to update its position on the map as it travels, other information that indicates roads, intersections, traffic control devices, geographic features, hazards, etc., or a combination thereof. In some implementations, map service server 490 may provide map or tracking data 492 associated with vehicle 401 to server 450 to enable server 450 to perform one or more operations described herein to support a sensor sharing configuration.

In some implementations, wireless communications system 400 implements a 5G NR network. For example, wireless communications system 400 may include multiple 5G-capable UEs 115, multiple 5G-capable vehicles 401, or multiple 5G capable network entities 430, such as UEs, vehicles, and network entities configured to operate in accordance with a 5G NR network protocol such as that defined by the 3GPP. In some other implementations, wireless communications system 400 implements a 6G network.

In some implementations, sensor sharing configuration 407 may be determined or selected by a network, such as server 450. For example, server 450 may be configured to determine a redundancy mitigation technique, a technique parameter, or a combination thereof. Server 450 may be configured to generate an indicator (e.g., 471, 474, or 476) that indicates sensor sharing configuration 407—e.g., a determined mitigation technique, a determine technique parameter, or a combination thereof—that a vehicle 401 or 422 or UE 115 should use. In some implementations, the indicator may include or indicate a region (e.g., 419) in which sensor sharing configuration 407 should be used. In some implementations, sensor sharing configuration 407 or the indicator that indicates sensor sharing configuration 407 may be communicated using an information element (IE), such as a sensor sharing configuration IE.

Sensor sharing configuration 407, the indicator of sensor sharing configuration 407, or the sensor sharing configuration IE, may be transmitted using sidelink communication (e.g., using a PC5 interface) or downlink communication (e.g., using a Uu interface). In some implementations, sensor sharing configuration 407, the indicator of sensor sharing configuration 407, or the sensor sharing configuration IE may be transmitted using PC5 dedicated signaling (unicast) over PC5-RRC in a message, such as a PC5-RRC message (e.g., RRCReconfigurationSidelink) or another PC5-RRC message. Additionally, or alternatively, sensor sharing configuration 407, the indicator of sensor sharing configuration 407, or the sensor sharing configuration IE may be transmitted using PC5 dedicated signaling (unicast) over PC5-S in a PC5-S message or another message. Additionally, or alternatively, sensor sharing configuration 407, the indicator of sensor sharing configuration 407, or the sensor sharing configuration IE may be transmitted using Uu dedicated signaling in a message, such as a radio resource control (RRC) message (e.g., RRCReconfiguration) or other message.

In some implementations, the sensor sharing configuration IE may include:

-- ASN1START
-- TAG-SIDELINKUEREDUNDANCYTECHNIQUENR-START
SidelinkUERedundancyTechnique-r16::= SEQUENCE {

| | |
|---|---|
| ue-FrequencyBasedRuleEnable | BOOLEAN, |
| ue-DistanceBasedRuleEnable | BOOLEAN, |
| ue-DynamicsBasedRuleEnable | BOOLEAN, |
| ue-ConfidenceBasedRuleEnable | BOOLEAN, |
| ue-EntropyBasedRuleEnable | BOOLEAN, |
| ue-ObjectSelfAnnouncementRuleEnable | BOOLEAN, |

}
FrequencyBasedRule-r16-IEs ::= SEQUENCE {

| | | |
|---|---|---|
| W-RedundancyFB-r16 | INTEGER (1..10000) | OPTIONAL, |
| N-RedundancyFB-r16 | INTEGER (1..100) | OPTIONAL, |

DistanceBasedRule-r16-IEs ::= SEQUENCE {

| | | |
|---|---|---|
| W-RedundancyDB-r16 | INTEGER (1..10000) | OPTIONAL, |
| R-RedundancyDB-r16 | INTEGER (1..1000) | OPTIONAL, |

DynamicsBasedRule-r16-IEs ::= SEQUENCE {

| | | |
|---|---|---|
| P-RedundancyDYB-r16 | INTEGER (1..1000) | OPTIONAL, |
| S-RedundancyDYB-r16 | INTEGER (1..100) | OPTIONAL, |

}
-- TAG-SIDELINKUEREDUNDANCYTECHNIQUENR -STOP
-- ASN1STOP

The sensor sharing configuration IE may include one or more fields (e.g., indicators 474) that indicate whether one or more redundancy mitigation techniques/rules are enabled, and optionally one or more parameters (e.g., parameters 476) associated with the one or more redundancy mitigation techniques/rules. In the fields of the example sensor sharing configuration IE, ue-FrequencyBasedRuleEnable may indicate whether or not a frequency-based redundancy mitigation rule is enabled (e.g., true), ue-DistanceBasedRuleEnable may indicate whether or not a distance-based redundancy mitigation rule is enabled (true), ue-DynamicsBasedRuleEnable may indicate whether or not a dynamics-based redundancy mitigation rule is enabled (true), ue-ConfidenceBasedRuleEnable may indicate whether or not a confidence-based redundancy mitigation rule is enabled (true), ue-EntropyBasedRuleEnable may indicate whether or not an entropy-based redundancy mitigation rule is enabled (true), and ue-ObjectSelfAnnouncementRuleEnable may indicate whether or not an object Self-Announcement redundancy mitigation rule is enabled (true). Additionally, in the fields of the example sensor sharing configuration IE, W-RedundancyFB-r16 may indicate the temporal window for the frequency-based redundancy mitigation rule, N-RedundancyFB-r16 may indicate the threshold detection instances for the frequency-based redundancy mitigation rule, W-RedundancyDB-r16 may indicate the temporal window for the distance-based redundancy mitigation rule, R-RedundancyDB-r16 may indicate the threshold distance for the distance-based redundancy mitigation rule, P-RedundancyDYB-r16 may indicate the threshold distance for the dynamics-based redundancy mitigation rule, and S-RedundancyDYB-r16 may indicate the threshold speed for the dynamics-based redundancy mitigation rule. In some implementations, a value of the temporal window for the frequency-based redundancy mitigation rule may be in milliseconds (ms), a value of the threshold detection instances for the frequency-based redundancy mitigation rule may indicate a number of detections, a value of the temporal window for the distance-based redundancy mitigation rule may be in ms, a value of the threshold distance for the distance-based redundancy mitigation rule may be in meters, a value of the threshold distance for the dynamics-based redundancy mitigation rule may be in meters, and a value of the threshold speed for the dynamics-based redundancy mitigation rule may be in meters/second (m/s).

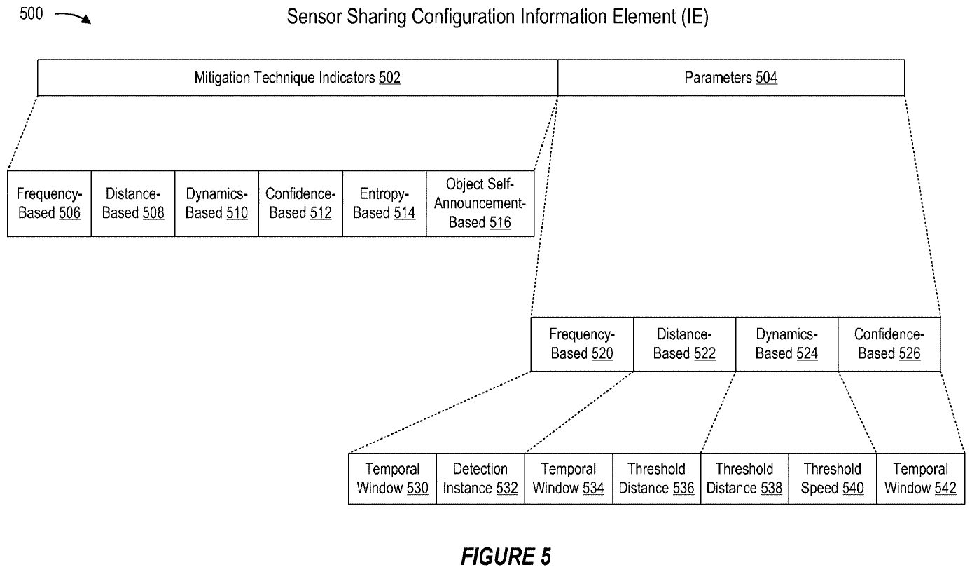

Referring to FIG. 5, FIG. 5 is block diagram illustrating an example format of an information element that supports a sensor sharing configuration according to one or more aspects. For example, the information element (IE) may include or correspond to a sensor sharing configuration IE 500. Sensor sharing configuration IE 500 may include or correspond to sensor sharing configuration 407, sensor sharing configuration indicator 471, sensor sharing configuration message 472 (including indicators 474 and, optionally, parameters 476), or a combination thereof.

Sensor sharing configuration IE 500 includes one or more fields. For example, the one or more fields may include mitigation technique indicators field 502, parameters field 504, or a combination thereof. As shown in FIG. 5, sensor sharing configuration IE 500 includes mitigation technique indicators field 502 and parameters field 504. Mitigation techniques indicators field 502 may include one or more sub-fields. The one or more sub-fields of mitigation techniques indicators field 502 may include a frequency-based mitigation technique field 506, a distance-based mitigation technique field 508, a dynamics-based mitigation technique field 510, a confidence-based mitigation technique field 512, an entropy-based mitigation technique field 514, an object self-announcement-based mitigation technique field 516, or a combination thereof. Frequency-based mitigation technique field 506 may be configured to indicate whether or not to enable a frequency-based mitigation technique, such as a frequency-based rule (e.g., Section 4.5.2 of ETSI TR 103 562 V2.1.1 (2019 December)). Distance-based mitigation technique field 508 may be configured to indicate whether or not to enable a distance-based mitigation technique, such as a distance-based rule (e.g., Section 4.5.7 of ETSI TR 103 562 V2.1.1 (2019 December)). Dynamics-based mitigation technique field 510 may be configured to indicate whether or not to enable a dynamics-based mitigation technique, such as a dynamics-based rule (e.g., Section 4.5.3 of ETSI TR 103 562 V2.1.1 (2019 December)). Confidence-based mitigation technique field 512 may be configured to indicate whether or not to enable a confidence-based mitigation technique, such as a confidence-based rule (e.g., Section 4.5.4 of ETSI TR 103 562 V2.1.1 (2019 December)). Entropy-based mitigation technique field 514 may be configured to indicate whether or not to enable an entropy-based mitigation technique, such as an entropy-based rule (e.g., Section 4.5.5 of ETSI TR 103 562 V2.1.1 (2019 December)). Object self-announcement-based mitigation technique field 516 may be configured to indicate whether or not to enable an object self-announcement-based mitigation technique, such as an object self-announcement rule (e.g., Section 4.5.6 of ETSI TR 103 562 V2.1.1 (2019 December)).

Parameters field 504 may include one or more sub-fields. The one or more sub-fields of parameters field 504 may include a frequency-based parameter field 520, a distance-based parameter field 522, a dynamics-based parameter field 524, a confidence-based parameter field 526, an entropy-based field (not shown), or a combination thereof. Frequency-based parameter field 520 may be associated with, correspond to, or indicate one or more parameters of frequency-based mitigation technique field 506. Frequency-based parameter field 520 may include one or more sub-fields, such as a temporal window field 530, a detection instance field 532, or a combination thereof. Temporal window field 530 may include or indicate a temporal window (W_{Redundancy}). Detection instance field 532 may include or indicate detection instances (N_{Redundancy}).

Distance-based parameter field 522 may be associated with, correspond to, or indicate one or more parameters of distance-based mitigation technique field 508. Distance-based parameter field 522 may include one or more sub-fields, such as a temporal window field 534, a threshold distance field 536, or a combination thereof. Temporal window field 534 may include or indicate a temporal window (W_{Redundancy}). Threshold distance field 536 may include or indicate a threshold distance (R_{Redundancy}). Dynamics-based parameter field 524 may be associated with, correspond to, or indicate one or more parameters of dynamics-based mitigation technique field 510. Dynamics-based parameter field 524 may include one or more sub-fields, such as a threshold distance field 538, a threshold speed field 540, or a combination thereof. Threshold distance field 538 may include or indicate a threshold distance (P_{Redundancy}). Threshold speed field 540 may include or indicate a threshold speed (S_{Redundancy}).

Confidence-based parameter field 526 may be associated with, correspond to, or indicate one or more parameters of confidence-based mitigation technique field 512. Confidence-based parameter field 526 may include one or more sub-fields, such as a temporal window field 542. Temporal window field 542 may include or indicate a temporal window (W_{Redundancy}). The entropy-based field (not shown) may be associated with, correspond to, or indicate one or more parameters of entropy-based mitigation technique field 514. The entropy-based field (not shown) may include one or more sub-fields, such as an entropy threshold field. The entropy threshold field may include or indicate an entropy threshold (E_{Redundancy}).

Referring back to FIG. 4, a message that include the sensor sharing configuration IE or the indicator of sensor sharing configuration 407 may be communicated to a single UE (e.g., a vehicle) or to a group of UEs. For example, the sensor sharing configuration IE or the indicator of sensor sharing configuration 407 may be transmitted by network entity 430 or server 450.

In some implementations, such as when the sensor sharing configuration IE or the indicator of sensor sharing configuration 407 is transmitted to a single UE, the sensor sharing configuration IE or the indicator of sensor sharing configuration 407 may be transmitted using a dedicated transmission distribution, such as PC5 dedicated signaling (unicast) or Uu dedicated signaling. For example, using PC5 dedicated signaling, the sensor sharing configuration IE or the indicator of sensor sharing configuration 407 may be encapsulated in PC5-RRC in a message, such as a PC5-RRC message (e.g., RRCReconfigurationSidelink). As another example, using PC5 dedicated signaling, the sensor sharing configuration IE or the indicator of sensor sharing configuration 407 may be encapsulated in PC5 Signaling (PC5-S) in a message, such as a PC5-S message. Additionally, or alternatively, using Uu dedicated signaling, the sensor sharing configuration IE or the indicator of sensor sharing configuration 407 may be encapsulated in RRC in a message, such as an RRC message (e.g., RRCReconfiguration)

In some implementations, such as when the sensor sharing configuration IE or the indicator of sensor sharing configuration 407 is transmitted to a group of UEs, the sensor sharing configuration IE or the indicator of sensor sharing configuration 407 may be transmitted using a common transmission distribution, such as PC5 common signaling or Uu common signaling. For example, using PC5 common signaling, the sensor sharing configuration IE or the indicator of sensor sharing configuration 407 may be encapsulated in an application-layer Broadcast message. As another example, using PC5 common signaling, the sensor sharing configuration IE or the indicator of sensor sharing configuration 407 may be encapsulated in an application-layer connection-less (distance-based) groupcast message. The application-layer connection-less (distance-based) groupcast message may be associated with a sender/application-specified range of interest, targeting a particular region (e.g., RSUs providing information specific to a radius about the RSU). Additionally, or alternatively, using Uu common signaling, the sensor sharing configuration IE or the indicator of sensor sharing configuration 407 may be encapsulated in a Uu SIB transmission, such as an SIB.

During operation of wireless communications system 400, server 450 may receive road congestion information associated with one or more regions. As an illustrative example, server 450 may receive road congestion information 470 that is associated with region 419, and road congestion information 470 may indicate, or be used to determine, road congestion, traffic congestion, OTA congestion, or a combination thereof, associated with region 419. Although illustrated in FIG. 4 as a single message, road congestion information 470 may include a single message from one device or multiple messages from multiple devices, such as UE 115, vehicle 422, network entity 430, other devices located within region 419 or possessing information related to region 419, or a combination thereof. In some implementations, road congestion information 470 includes one or more safety messages or awareness messages communicated by vehicles or other UEs according to a V2X standard. For example, road congestion information 470 may include one or more BSMs, one or more CAMs, or a combination thereof, from one or more RSUs (e.g., network entity 430) located within region 419. Additionally, or alternatively, road congestion information 470 may include one or more channel busy ration (CBR) measurements reported by vehicles (e.g., vehicle 422), RSUs (e.g., network entity 430), or a combination thereof, located within region 419. Additionally, or alternatively, road congestion information 470 may include one or more CBR measurements reported by one or more base stations (e.g., network entity 430) that serve region 419. Additionally, or alternatively, road congestion information 470 may include traffic camera data associated with region 419, lane metering data associated with region 419, temporal congestion data associated with region 419, other information, or a combination thereof. In a similar manner to road congestion information 470 for region 419, road congestion information for other regions may be received by server 450.

Server 450 may also receive travel information associated with one or more vehicles. For example, vehicle 401 may send travel information 406 to server 450, such as when vehicle 401 starts a trip, periodically during operation, upon request from server 450, upon request from an operator of vehicle 401, or a combination thereof. Travel information 406 may include or indicate information associated with movement or travel vehicle 401, such as from an original location to a destination. For example, travel information 406 may indicate a position of vehicle 401, a speed of vehicle 401, a heading of vehicle 401, a direction of travel of vehicle 401, or a combination thereof. In some implementations, travel information 406 includes or corresponds to one or more basic safety messages (BSMs), one or more cooperative awareness messages (CAMs), one or more collective perception messages (CPMs), one or more sensor data sharing messages (SDSMs), other types of vehicle or V2X messaging, or a combination thereof.

After receiving road congestion information 470 and travel information 406, server 450 may determine road congestion metric 464 that is associated with destination region 462 (e.g., region 419) based on road congestion information 470. In some implementations, server 450 may identify, based on travel information 406, destination region 462 in which one or more vehicles (e.g., vehicle 401) are expected to be located at a future time. As described above, destination region 462 may be a region in which an end location (e.g., a final destination) of vehicle 401 is located, and optionally one or more intermediate or intervening regions between that region and a region in which vehicle 401 is presently located. Destination region 462 may be directly provided by vehicle 401 (e.g., in travel information 406) or by map service server 490 (e.g., in map or tracking data 492), or server 450 may identify destination region 462 based on travel information 406. For example, server 450 may identify destination region 462 by extrapolating an expected location or region of vehicle 401 based on a location of vehicle 401, a heading of vehicle 401, a speed of vehicle 401, or a combination thereof. In the example depicted in FIG. 4, destination region 462 may include or correspond to region 419.

Server 450 may also use information from other sources to identify, or to refine the identification, of destination region 462. In some implementations, server 450 may receive map or tracking data 492 from map service server 490, such as from periodic transmission of map or tracking data 492 or upon request. Map or tracking data 492 may include or indicate map data associated with vehicle 401 (e.g., map(s) of a travel path from a first destination to a second destination), tracking data associated with vehicle 401 (e.g., a current or estimated position of vehicle 401 along a travel path or a relative location with respect to one or more waypoints or other tracked features), or a combination thereof. Server 450 may identify destination region 462 based on map or tracking data 492, such as by extracting a final destination that corresponds to destination region 462 or one or more regions between vehicle 401 and a target destination that correspond to destination region 462. Additionally, or alternatively, server 450 may identify or refine destination region 462 based further on road topology information 468. For example, an initial estimation of destination region 462 may cover a large area, and server 450 may omit portions of the area that are not connected by one or more roads to the current location of vehicle 401, as indicated by road topology information 468. As another example, server 450 may determine that vehicle 401 is presently located on an expressway that does not have an exit for five miles, as indicated by road topology information 468, and server 450 may refine an initial determination of destination region 462 to exclude or omit a portion that is located within five miles of the current position of vehicle 401 and not accessible by the exit. Additionally, or alternatively, server 450 may identify destination region 462 based on historical travel data 469. For example, if historical travel data 469 indicates that vehicle 401 typically travels on weekdays from a first location (e.g., home) to a second location (e.g., work) between 9:00 and 10:00 am on weekdays, and it is 9:15 on a Tuesday, server 450 may identify destination region 462 as the region that includes the second location.

Server 450 may determine road congestion metric 464 based on road congestion information 470 that corresponds to the determined destination region 462. For example, server 450 may determine a number of vehicles within region 419 (e.g., destination region 462) that transmit the messages included in road congestion information 470 or that are identified by road congestion information 470. Other road congestion metrics are also possible. As described above, road congestion metric 464 may include a quantity of vehicles located within destination region 462, trends in the quantity of vehicles located within destination region 462, counts of safety messages being communicated within destination region 462, channel metrics associated with destination region 462, other metrics, or a combination thereof.

After determining road congestion metric 464, server 450 may generating an indicator of sensor sharing configuration 407 based on road congestion metric 464. For example, server 450 may perform a comparison of road congestion metric 464 to thresholds 466 to generate the indicator, and based on result(s) of the comparison, server 450 may select which, or how many, sensor sharing mitigation techniques, and optionally associated parameters, to be included in sensor sharing configuration 407. For example, server 450 may compare a determined quantity of vehicles within destination region 462 to a threshold number of vehicles, a reported CBR to a threshold CBR, or a current maximum sensor sharing packet size reported by a UE that can be transmitted without error to a threshold packet size, as non-limiting examples, to determine which sensor sharing mitigation techniques to select, or whether to increase or decrease overall sensor sharing mitigation. In some implementations, different sensor sharing mitigation techniques may correspond to different ones of thresholds 466, different vehicle types, different regions, or other considerations, and server 450 may select which sensor sharing mitigation techniques to include in sensor sharing configuration 407 based on the comparison of road congestion metric 464 to thresholds 466, a type of vehicle 401, destination region 462, the other considerations, or a combination thereof. As an illustrative example, server 450 may determine sensor sharing configuration 407 (e.g., by selecting sensor sharing mitigation techniques and optionally parameters) to increase sensor sharing mitigation (e.g., reduce redundancy) based on road congestion metric 464 satisfying one or more of thresholds 466 (e.g., indicating that there is a relatively large amount of road congestion in destination region 462) . . . . As another example, server 450 may determine sensor sharing configuration 407 to decrease sensor sharing mitigation (e.g., increase redundancy) based on road congestion metric 464 failing to satisfy one or more of thresholds 466 (e.g., indicating that there is a relatively small amount of road congestion in destination region 462).

After determining sensor sharing configuration 407 based on road congestion metric 464 and travel information 406, server 450 transmits sensor sharing configuration indicator 471 to enable vehicle 401 to perform the indicated sensor sharing mitigation technique(s). In some implementations, server 450 transmits sensor sharing configuration indicator 471 to network entity 430 (e.g., a RSU, a base station, or the like), and network entity 430 transmits sensor sharing configuration message 472 to vehicle 401, such as when vehicle 401 is within region 419. In some such implementations, network entity 430 may perform some of the sensor sharing mitigation selection. For example, sensor sharing configuration indicator 471 may indicate whether sensor sharing mitigation is to be performed, and network entity 430 may select which sensor sharing mitigation techniques to include in sensor sharing configuration message 472, such as based on information associated with region 419, information associated with network entity 430, information associated with vehicle 401, other information, or a combination thereof. Alternatively, sensor sharing configuration indicator 471 may include the information, and network entity 430 may simply forward or pass on sensor sharing configuration indicator 471 as sensor sharing configuration message 472. In still other implementations, server 450 may transmit sensor sharing configuration message 472 directly to vehicle 401.

In some implementations, sensor sharing configuration indicator 471, sensor sharing configuration message 472, or both, include indicators 474 of one or more sensor sharing mitigation techniques to be performed at vehicle 401. For example, the one or more sensor sharing mitigation techniques that correspond to indicator 474 may include a frequency-based mitigation technique, a distance-based mitigation technique, a dynamics-based mitigation technique, a confidence-based mitigation technique, an entropy-based mitigation technique, an object self-announcement-based mitigation technique, or a combination thereof. In some such implementations, sensor sharing configuration indicator 471, sensor sharing configuration message 472, or both, also indicate parameters 476 associated with indicators 474 (e.g., the one or more sensor sharing mitigation techniques). For example, parameters 476 may include temporal window(s) (e.g., WRedundancy), detection instances (e.g., NRedundancy), threshold distance(s) (e.g., RRedundancy, PRedundancy), threshold speed(s) (e.g., SRedundancy), entropy threshold(s) (e.g., ERedundancy) or a combination thereof.

In some implementations, network entity 430 may transmit sensor sharing configuration message 472 to vehicle 401 via one or more downlink communications, such as one or more Uu communications. For example, network entity 430 may transmit sensor sharing configuration message 472 to a single vehicle (e.g., vehicle 401), and sensor sharing configuration message 472 may be included in or correspond to an RRC message. Alternatively, network entity 430 may transmit sensor sharing configuration message 472 to multiple vehicles, including vehicle 401, and sensor sharing configuration message 472 may be included in or correspond to a system information block (SIB) message. In some other implementations, network entity 430 may transmit sensor sharing configuration message 472 via one or more sidelink communications, such as one or more PC5 communications. For example, network entity 430 may transmit sensor sharing configuration message 472 to a single vehicle (e.g., vehicle 401), and sensor sharing configuration message 472 may be included in or correspond to a sidelink radio resource control (RRC) message or a sidelink signaling message (e.g., a PC5-S message). Alternatively, network entity 430 may transmit sensor sharing configuration message 472 to multiple vehicles, including vehicle 401, that are located within a particular range from network entity 430 (e.g., using a distance-based sidelink groupcast transmission). In some other implementations, network entity 430 may broadcast sensor sharing configuration message 472 to all vehicles within a maximum communication range of network entity 430.

Vehicle 401 may receive sensor sharing configuration message 472 and implement the sensor sharing mitigation techniques when located within destination region 462 (e.g., region 419), immediately upon receipt of sensor sharing configuration message 472, or at an indicated future time. In this manner, vehicle 401 may perform sensor sharing mitigation (e.g., redundancy mitigation) in accordance with the techniques selected by server 450. For example, at a future time, vehicle 401 may generate information to be communicated to another device. This information may include sensor information 478, such as sensor information to be included in a CPM. Vehicle 401 may apply one or more sensor sharing mitigation techniques indicated by sensor sharing configuration message 472 to generate a message 477 for transmission to another device. For example, message 477 may include sensor information 478 that satisfies or is generated in accordance with one or more sensory sharing mitigation rules selected by 450 and may omit at least some sensor information that does not satisfy or is not in accordance with the sensory sharing mitigation rules.

As described with reference to FIG. 4, the present disclosure provides techniques for supporting a sensor sharing configuration (e.g., a redundancy mitigation technique), such as sensor sharing configuration 407, based on input from OBUs, RSUs, base stations, and ancillary services (e.g., map service server 490) over sidelink (e.g., PC5) or network-based (e.g., Uu) communications. For example, server 450 may be configured to proactively determine sensor sharing configuration 407 for vehicle 401 based on travel information 406 and road congestion metric 464. Additionally, or alternatively, server 450 may perform sensor sharing mitigation parameter adjustment based on travel information and road congestion metric 464. By proactively determining sensor sharing configuration 407 for destination region 462 that vehicle 402 has not yet traveled to, the network may enable more efficient spectrum utilization for one or more devices located within destination region 462 (e.g., region 419) as compared to relying on vehicle 401 to select a sensor sharing configuration without information related to region 419, which may be too far for vehicle 401 to measure. For example, wireless communications system 400 may experience improved communications, including reduced network channel load (e.g. reduced OTA congestion) due to channel sharing mitigation techniques that are selected based on more relevant information, improved network efficiency, improved resource and energy utilization, improved traffic safety messaging, a reduction in traffic accidents, or a combination thereof. The framework for messages and the techniques described herein may be standardized within one or more 3GPP V2X standards (e.g., (38.331, 24.587, or other standards or sections) or one or more application-layer standards (e.g., SAE, ETSI-ITS, C-SAE), some of which have already identified redundancy mitigation techniques for OBUs and RSUs to reduce redundant reporting of detected objects by multiple OBUs or RSUs.

FIG. 6 is a flow diagram illustrating an example process 600 that supports a sensor sharing configuration according to one or more aspects. Operations of process 600 may be performed by a server, such as server 450 described above with reference to FIG. 4 or a server as described with reference to FIG. 12, core network 130, or a management function. For example, example operations (also referred to as “blocks”) of process 600 may enable the server, such as a cloud entity, to support a sensor sharing configuration.

In block 602, the server collects road congestion information. The road congestion information may include or correspond to road congestion information 470. The road congestion information may be associated with one or more regions, such as region 419. In some implementations, the road congestion information may include or correspond to regional OTA congestion information. For example, the road congestion information collected by the server may be representative of or associated with OTA congestion, or the OTA congestion information collected by the server may be representative of or associated with road congestion.

To collect the road congestion information, the server may receive information from one or more network entities (e.g., 430), such as a UE (e.g., 115), a vehicle (e.g., 401 or 422) or an OBU, a base station (e.g., 105), an RSU, a traffic control device, or a combination thereof. For example, in block 604, the server collects RSU-collected BSMs, CAMs, or other vehicle-transmitted sidelink message(s). The sidelink message may include one or more PC5-messages. As another example, in block 606, the server collects vehicle- or RSU-reported CBR measurements. In some implementations, vehicle-reported CBR measurements may include OBU-reported CBR measurements. As another example, in block 608, the server collects base station-reported CBR measurements. As another example, in block 610, the server collects vehicular and congestion data. The vehicular and congestion data may include data or information received from one or more traffic control devices, such as a traffic camera or a lane metering device, as illustrative, non-limiting examples. Although collecting the road congestion information in block 602 is described as including each of blocks 604, 606, 608, and 610, in other implementations, collecting the road congestion information in block 602 may not include one or more of blocks 604, 606, 608, or 610.

In block 612, the server overlays road congestion on a map. The road congestion may be determined based on the road congestion information collected by the server. For example, the road congestion may include or indicate one or more levels of congestion of a road, an area, or a region. In some implementations, the road congestion may include or correspond to OTA congestion. The map may include or correspond to map data, such as road topology information 468, map or tracking data 492, or a combination thereof.

In block 614, the server determines a location of a vehicle (or an OBU of the vehicle), a motion state of a vehicle (or the OBU of the vehicle), or a combination thereof. The motion state may include a speed of the vehicle, a heading of the vehicle, or a combination thereof, as illustrative, non-limiting examples. In some implementations, the location and the motion state may include or be associated with a current location and a current motion state of the vehicle. The vehicle may include or correspond to vehicle 401 or 422.

To determine the location or the motion station of the vehicle (or the OBU), the server may receive information from one or more network entities (e.g., 430), such as a vehicle (e.g., 401 or 422) or an OBU, a third party application or server, or a combination thereof. For example, in block 616, the server receives a vehicle-transmitted sidelink message. The vehicle-transmitted sidelink message may include a BSM, a CAM, a CPM, an SDSM, maneuver coordination information, or a combination thereof. The vehicle-transmitted sidelink message may include or correspond to travel information 406, message 477, or sensor information 478. In some implementations, the vehicle-transmitted sidelink message includes or corresponds to a PC5-message. As another example, in block 618, the server receives mapping data, tracking data, or a combination thereof. The mapping data, the tracking data, or a combination thereof, may include or correspond to map or tracking data 492. The mapping data, the tracking data, or a combination thereof may be received from a third party service or application, such as a third party server (e.g., 490). To illustrate, the third party service or application may include or correspond to Google Maps, Apple Maps, Life360, or OnStar Guardian, as illustrative, non-limiting example. Although determining the location or the motion state of the vehicle (or the OBU) in block 614 is described as including each of blocks 616 and 618, in other implementations, determining the location or the motion state of the vehicle (or the OBU) in block 614 may not include one or more of blocks 616 or 618.

In block 620, the server estimates a future location of the vehicle. For example, the future location of the vehicle may be a destination region of the vehicle, such as a final destination region or an intermediate destination region. The destination region may include or correspond to region 419 or destination region 462. Estimating the future location of the vehicle may include the server inferring or predicting the future location of the vehicle. The server may estimate (e.g., infer or predict) the future location of the vehicle based on the location of the vehicle (or the OBU), the motion state of the vehicle (or the OBU), or a combination thereof, such as by extrapolating a travel path to a future time based on this information. Additionally, or alternatively, the server may estimate (e.g., infer or predict) the future location of the vehicle based on road topology information, destination information, historical travel information, or a combination thereof. The road topology information may include or correspond to road topology information 468. The historical travel information may include or correspond to information from a mapping application, such as a third party mapping application—e.g., map service server 490. The historical travel information may include or correspond to historical travel data 469.

In block 622, the server determines a sensor sharing mitigation technique based on or associated with the future location of the vehicle. The sensor sharing mitigation technique may be associated with sensor sharing configuration 407, sensor sharing configuration indicator 471, sensor sharing configuration message 472, indicators 474, parameters 476, sensor sharing configuration IE 500, or a combination thereof. In some implementations, the sensor sharing mitigation technique is determined based on road congestion information at destination region (e.g., a future location of the vehicle), road congestion information associated with a current location of the vehicle, along a route that the vehicle travels, or a combination thereof. In some implementations, the server may determine a sensor sharing configuration that includes or indicates the sensor sharing mitigation technique. The sensor sharing configuration may be associated with sensor sharing configuration 407, sensor sharing configuration indicator 471, sensor sharing configuration message 472, indicators 474, parameters 476, sensor sharing configuration IE 500, or a combination thereof. In some implementations, the sensor sharing mitigation technique, a parameter of the sensor sharing mitigation technique, the sensor sharing configuration, or a combination thereof, may be determined for the vehicle, the destination region, a region other than the destination region, or a combination thereof.

In block 624, the server transmits a sensor sharing mitigation configuration message to one or more vehicles. The sensor sharing mitigation configuration message may include or indicate the determined sensor sharing mitigation technique. The sensor sharing mitigation configuration message may include or correspond to sensor sharing configuration 407, sensor sharing configuration indicator 471, sensor sharing configuration message 472, indicators 474, parameters 476, sensor sharing configuration IE 500, or a combination thereof.

To transmit the sensor sharing mitigation configuration message, in block 626, the server transmits the sensor sharing mitigation configuration message to an individual vehicle via a dedicated sidelink or downlink signaling. For example, the server may transmit the sensor sharing mitigation configuration message over a PC5 link or a Uu link. Additionally, or alternatively, to transmit the sensor sharing mitigation configuration message, in block 628, the server transmits the sensor sharing mitigation configuration message to multiple vehicles via common sidelink signaling or via downlink signaling. For example, the server may transmit the sensor sharing mitigation configuration message over a PC5 link or a Uu link to multiple devices, such as via broadcasting or distance-based groupcasting, as non-limiting examples. Although transmitting the sensor sharing mitigation configuration message in block 624 is described as including each of blocks 626 and 628, in other implementations, transmitting the sensor sharing mitigation configuration message in block 624 may not include one or more of blocks 626 or 628.

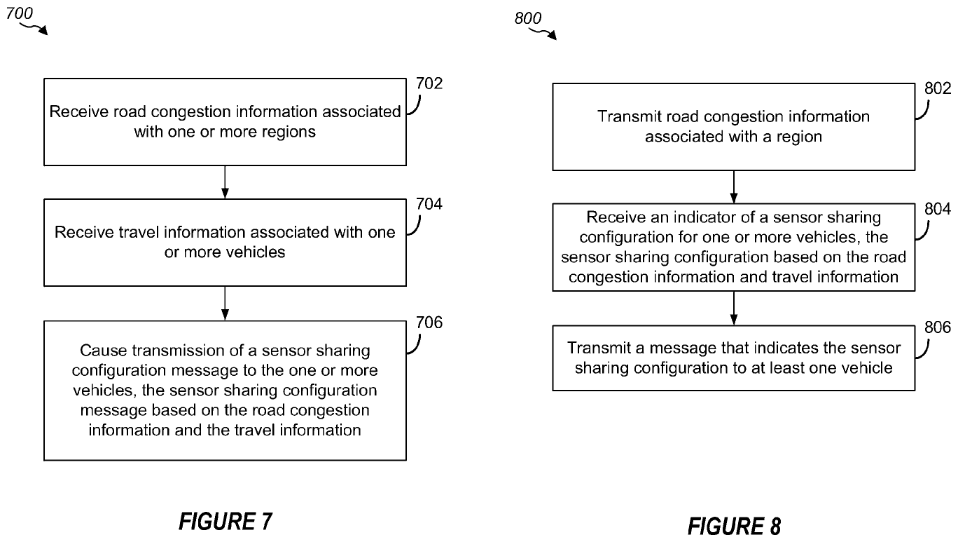

FIG. 7 is a flow diagram illustrating an example process 700 that supports a sensor sharing configuration according to one or more aspects. Operations of process 700 may be performed by a server, such as server 450 described above with reference to FIG. 4 or a server as described with reference to FIG. 12, core network 130, or a management function. For example, example operations (also referred to as “blocks”) of process 700 may enable the server to support a sensor sharing configuration.

In block 702, the server receives road congestion information associated with one or more regions. The road congestion information may include or correspond to road congestion information 470 or information 437. The one or more regions may include or correspond to region 419. The road congestion information may be received from a network entity, such as base station 105, an RSU, network entity 430, or a combination thereof. To illustrate, the road congestion information may be received from one or more RSUs, such as one or more RSUs located within or near the one or more regions.

In some implementations, the road congestion information includes, is included in, or is indicated by one or more BSMs, one or more CAMs, or a combination thereof. Additionally, or alternatively, the road congestion information may include or indicate one or more CBR measurements. The one or more CBR measurements may be generated by a vehicle, an RSU, a network entity, a base station, or a combination thereof. To illustrate, the road congestion information (that includes or indicates the one or more CBR measurements) may be received from a base station that is located within, located near, or serve at least a portion of the one or more regions. In some implementations, the road congestion information includes traffic camera data associated with the one or more regions, lane metering data associated with the one or more regions, temporal congestion data associated with the one or more regions, or a combination thereof.

In block 704, the server receives travel information associated with one or more vehicles. The travel information may include or correspond to travel information 406. The one or more vehicles may include or correspond to vehicle 401 or vehicle 422. The travel information may indicate, for a first vehicle of the one or more vehicles, a position of the first vehicle, a speed of the first vehicle, a heading of the first vehicle, a direction of travel of the first vehicle, or a combination thereof. The travel information includes, is included in, or is indicated by one or more BSMs, one or more CAMs, one or more CPMs, one or more SDSMs, or a combination thereof.

In block 706, the server transmits an indicator of a sensor sharing configuration for the one or more vehicles. The indicator may include or correspond to sensor sharing configuration 407, sensor sharing configuration indicator 471, sensor sharing configuration message 472, indicator 474, parameter 476, sensor sharing configuration IE 500, or a combination thereof. The sensor sharing configuration may include or correspond to sensor sharing configuration 407. The sensor sharing configuration may be based on the road congestion information, the travel information, or a combination thereof. In some implementations, the sensor sharing configuration is based on the road congestion information and the travel information. In some implementations, the sensor sharing configuration is associated with a region of the one or more regions.

In some implementations, the indicator of the sensor sharing configuration includes or indicates one or more sensor sharing mitigation techniques to be performed at the one or more vehicles. For example, the one or more sensor sharing mitigation techniques include a frequency-based mitigation technique, a distance-based mitigation technique, a dynamics-based mitigation technique, a confidence-based mitigation technique, an entropy-based mitigation technique, an object self-announcement-based mitigation technique, or a combination thereof. Additionally, or alternatively, the indicator of the sensor sharing configuration includes or indicates one or more parameters associated with the one or more sensor sharing mitigation techniques. The one or more parameters include a temporal window, detection instances, a threshold distance, a threshold speed, a threshold entropy, or a combination thereof.

In some implementations, the server identifies, based on the travel information, a destination region of the one or more regions in which the one or more vehicles are expected to be located at a future time. For example, the server may identify a destination region that a vehicle is traveling towards. The destination region may include or correspond to region 419 or destination region 462. Additionally, or alternatively, the server may determine a road congestion metric associated with the destination region based on the road congestion information. For example, the road congestion metric may be associated with the destination region or another region, such as a region through with the vehicle is expected to travel. The road congestion metric may include or correspond to road congestion metric 464. In some implementations, the server performs a comparison based on the road congestion metric and a threshold. The threshold may include or correspond to threshold 466. Additionally, or alternatively, the server may generate the indicator of the sensor sharing configuration based on the comparison, such as a comparison of the road congestion metric to a threshold. In some implementations, to generate the indicator of the sensor sharing configuration, the server determines the sensor sharing configuration to increase sensor sharing mitigation at the one or more vehicles based on the road congestion metric satisfying the threshold. Alternatively, to generate the indicator of the sensor sharing configuration, the server determines the sensor sharing configuration to decrease sensor sharing mitigation at the one or more vehicles based on the road congestion metric satisfying the threshold.

In some implementations, the server receives map data associated with the one or more vehicles, tracking data associated with the one or more vehicles, or a combination thereof. The map data, the tracking data, or a combination thereof may include or correspond to map or tracking data 492. In some such implementations, the destination region is identified based further on the map data, the tracking data, or a combination thereof. Additionally, or alternatively, the destination region may be determined based further on road topology information associated with a road on which the one or more vehicles are traveling, historical travel data associated with the one or more vehicles, or a combination thereof. The road topology information may include or correspond to road topology information 468. The historical travel data may include or correspond to historical travel data 469.

In some implementations, to transmit the indicator of the sensor sharing configuration, the server initiate transmission of the indicator or the sensor sharing configuration via one or more downlink communications. In some implementations, the one or more vehicles include a single vehicle, and the indicator of the sensor sharing configuration is included in an RRC message. Alternatively, the one or more vehicles includes multiple vehicles, and the indicator of the sensor sharing configuration is included in an SIB message.

In some implementations, the one or more vehicles includes a single vehicle, and the indicator is transmitted to another network entity to cause the other network entity to transmit the sensor sharing configuration to the single vehicle via a sidelink communication, the indicator of the sensor sharing configuration may be included in a sidelink RRC message or a sidelink signaling message. In some implementations, to provide the indicator or the sensor sharing configuration to the one or more vehicles, the server may transmit the indicator to a network entity, such as a base station or an RSU, and the network entity may transmit the indicator or the sensor sharing configuration to the one or more vehicles. In some such implementations, the indicator is transmitted to one or more network entities to cause the one or more other network entities to broadcast the sensor sharing configuration via one or more sidelink communications. Additionally, or alternatively, to transmit the indicator of the sensor sharing configuration, the sensor may cause one or more other network entities to transmit the sensor sharing configuration to one or more vehicles located within a particular range from the one or more other network entities via one or more sidelink communications.

In some implementations, the server receives second travel information associated with one or more other vehicles. The second travel information may include or correspond to travel information 406. The server may transmit a second indicator of a second sensor sharing configuration for the one or more other vehicles. The second indicator may include or correspond to sensor sharing configuration 407, sensor sharing configuration indicator 471, sensor sharing configuration message 472, indicator 474, parameter 476, sensor sharing configuration IE 500, or a combination thereof. The second sensor sharing configuration may include or correspond to sensor sharing configuration 407. The second sensor sharing configuration may be based on the road congestion information and the second travel information. The sensor sharing configuration may be associated with a first destination region of the one or more regions that is different than the second sensor sharing configuration that is associated with a second destination region of the one or more regions. The second destination region may be different from the first destination region.

FIG. 8 is a flow diagram illustrating an example process 800 that supports a sensor sharing configuration according to one or more aspects. Operations of process 800 may be performed by a network entity, such as UE 115z of FIG. 1, base station 105 of FIGS. 1-3, network entity 430 of FIG. 4, or a network entity as described with reference to FIG. 11. For example, example operations of process 800 may enable the network entity to support a sensor sharing configuration.

At block 802, the network entity transmits road congestion information associated with a region. For example, the road congestion information may include or correspond to road congestion information 470. In some implementations, the network entity may transmit a BSMs or CAMs that includes the road congestion information.

At block 804, the network entity receives an indicator of a sensor sharing configuration for one or more vehicles. The indicator may include or correspond to sensor sharing configuration indicator 471. The sensor sharing configuration may include or correspond to sensor sharing configuration 407, sensor sharing configuration indicator 471, sensor sharing configuration message 472, indicator 474, parameter 476, sensor sharing configuration IE 500, or a combination thereof. The one or more vehicles may include or correspond to vehicle 401 or 422. The sensor sharing configuration may be based on the road congestion information, travel information associated with a vehicle, or a combination thereof. The travel information associated with the vehicle may include or correspond to travel information 406. In some implementations, the sensor sharing configuration may be based on the road congestion information and travel information associated with a vehicle.

At block 806, the network entity transmits a message that indicate the sensor sharing configuration to at least one vehicle. The message may include or correspond to sensor sharing configuration message 472, indicator 474, parameter 476, sensor sharing configuration IE 500, or a combination thereof. In some implementations, the network entity may generate the message based on the received indicator. Additionally, or alternatively, the network entity may transmit the message using a dedicated sidelink, a common sidelink, or downlink signaling.

In some implementations, the network entity receives the indicator and a region indicator, a vehicle indicator, or a combination thereof. The network entity may generate the message and transmit the message based on the region indicator, the vehicle indicator, or a combination thereof. For example, the network entity may transmit the message to one or more vehicles located in a region (e.g., 419) that corresponds to or is indicated by the region indicator. As another example, the network entity may transmit the message to one or more vehicles based on the vehicle indicator, such as a vehicle indicator that indicates an individual vehicle, or indicates a group or platoon of multiple vehicles.

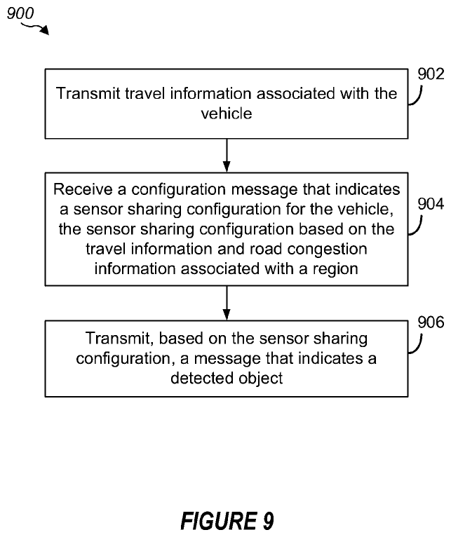

FIG. 9 is a flow diagram illustrating an example process 900 that supports a sensor sharing configuration according to one or more aspects. Operations of process 900 may be performed by a vehicle, such as vehicle 401 or 422 described above with reference to FIG. 4 or a vehicle described with reference to FIG. 7, or UE 115i, 115j, 115k described above with reference to FIGS. 1-2. For example, example operations (also referred to as “blocks”) of process 900 may enable the vehicle to support a sensor sharing configuration.

In block 902, the vehicle transmits travel information associated with the vehicle. The travel information may include or correspond to travel information 406. In some implementations, the travel information includes or indicates a route of the vehicle, a destination of the vehicle, a region in which the vehicle is located, a motion state (e.g., a speed or a heading) of the vehicle, or a combination thereof. Additionally, or alternatively, the travel information may be included in or indicated by a BSM, a CAM, a CPM, an SDSM, maneuver coordination information, or a combination thereof, that is generated or transmitted by the vehicle.

In block 904, the vehicle receives a configuration message that indicates a sensor sharing configuration for the vehicle. The configuration message may include or correspond to sensor sharing configuration indicator 471, sensor sharing configuration message 472, indicator 474, parameter 476, sensor sharing configuration IE 500, or a combination thereof. The sensor sharing configuration may include or correspond to indicator 474, parameter 476, sensor sharing configuration 407, or a combination thereof. The sensor sharing configuration may be based on the travel information (e.g., 406). Additionally, the sensor sharing configuration may be based on road congestion information associated with a region. For example, the road congestion information may include or correspond to road congestion information 470. The region may include or correspond to region 419.

In some implementations, the configuration message, the sensor sharing configuration, or a combination thereof may include or indicate a region indicator, a vehicle indicator, or a combination thereof. For example, the region indicator may indicate one or more regions (e.g., 419) for which the sensor sharing configuration is to be applied. As another example, the vehicle indicator may indicate one or more vehicles (e.g., an individual vehicle, or indicates a group or platoon of multiple vehicles) for which the sensor sharing configuration is to be applied.

In block 906, the vehicle transmits, based on the sensor sharing configuration, a message that indicates a detected object. For example, the vehicle may detect an object based on sensor data generated by one or more sensors of the vehicle. The one or more sensors of the vehicle may be configured based on the received sensor sharing configuration. The message may include or correspond to message 477, sensor information 478, or a combination thereof.

In some implementations, the vehicle may configure one or more components, such as an OBU, of the vehicle based on the sensor sharing configuration. Additionally, or alternatively, the vehicle may generate sensor data/information. The vehicle may generate the message (that indicates the detected object) based on or according to the sensor sharing configuration.

FIG. 10 is a perspective view of a motor vehicle with a driver monitoring system according to one or more aspects. A vehicle 1000 may include or communication with a UE within a wireless network 100, as shown in FIG. 1. In some implementations, vehicle 1000 may include or correspond to UE 115i, 115j, or 115k, vehicle 411, or vehicle 422. One or more components described with reference to vehicle 1000 may include or correspond to one or more components as described with reference to at least vehicle 401. For example, the one or more components described with reference to vehicle 1000 may include one or more sensors of vehicle 401. The one or more sensors may be configured or used to generate sensor information, such as sensor information 478.

Vehicle 1000 may include a front-facing camera 1012 mounted inside the cabin looking through a windshield 1002. Vehicle 1000 may also include a cabin-facing camera 1014 mounted inside the cabin looking towards occupants of vehicle 1000, and in particular the driver of vehicle 1000. Although one set of mounting positions for cameras 1012 and 1014 are shown for vehicle 1000, other mounting locations may be used for camera 1012 or camera 1014. For example, one or more cameras may be mounted on one of the driver or passenger pillars 1026 or one of the driver or passenger pillars 1028, such as near the top of the pillars 1026 or 1028. As another example, one or more cameras may be mounted at the front of vehicle 1000, such as behind the radiator grill 1030 or integrated with bumper 1032. As a further example, one or more cameras may be mounted as part of a driver or passenger side mirror assembly 1034.

Camera 1012 may be oriented such that the field of view of camera 1012 captures a scene in front of vehicle 1000 in the direction that vehicle 1000 is moving when in drive mode or forward direction. In some embodiments, an additional camera may be located at the rear of vehicle 1000 and oriented such that the field of view of the additional camera captures a scene behind vehicle 1000 in the direction that vehicle 1000 is moving when in reverse direction. Although aspects of the disclosure may be described with reference to a “front-facing” camera, referring to camera 1012, the aspects of the disclosure may be applied similarly to a “rear-facing” camera facing in the reverse direction of vehicle 1000. Thus, the benefits obtained while the operator is operating vehicle 1000 in a forward direction may likewise be obtained while the operator is operating vehicle 1000 in a reverse direction.

Further, although embodiments of the disclosure may be described with reference a “front-facing” camera, referring to camera 1012, aspects of the disclosure may be applied similarly to an input received from an array of cameras mounted around vehicle 1000 to provide a larger field of view, which may be as large as 360 degrees around parallel to the ground and/or as large as 360 degrees around a vertical direction perpendicular to the ground. For example, additional cameras may be mounted around the outside of vehicle 1000, such as on or integrated in the doors, on or integrated in the wheels, on or integrated in the bumpers, on or integrated in the hood, and/or on or integrated in the roof.

Camera 1014 may be oriented such that the field of view of camera 1014 is configured to capture a scene in the cabin of vehicle 1000 and includes the user operator of vehicle 1000. In some implementations, camera 1014 is configured to capture the face of the user operator of vehicle 1000 with sufficient detail to discern a gaze direction of the user operator.

Each of cameras 1012 and 1014 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

Vehicle 1000 may include, or otherwise be coupled to, an image signal processor for processing image frames from one or more image sensors, such as a first image sensor, a second image sensor, and a depth sensor. Vehicle 1000 may further include or be coupled to a power supply, such as a battery or an alternator. Vehicle 1000 may also include or be coupled to one or more features of FIG. 2, one or more additional features or components that are not shown in FIG. 2, or a combination thereof.

Vehicle 1000 may include a sensor hub for interfacing with sensors to receive data regarding movement of vehicle 1000, data regarding an environment around vehicle 1000, or other non-camera sensor data. The sensor hub may include or be coupled to one or more sensors. One example non-camera sensor is a gyroscope, a device configured for measuring rotation, orientation, or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub may interface to a vehicle bus for sending configuration commands and/or receiving information from vehicle sensors, such as distance (e.g., ranging) sensors or vehicle-to-vehicle (V2V) sensors (e.g., sensors for receiving information from nearby vehicles).

FIG. 11 is a block diagram of an example network entity 1100 that supports a sensor sharing configuration according to one or more aspects. Network entity 1100 may be configured to perform operations, including the blocks of a process described with reference to FIG. 1-4, 6 or 8. In some implementations, network entity 1100 includes the structure, hardware, and components shown and described with reference to UE 115, base station 105, vehicle 401, vehicle 422, an RSU, or network entity 430. For example, network entity 1100 includes controller 280, which operates to execute logic or computer instructions stored in memory 282, as well as controlling the components of network entity 1100 that provide the features and functionality of network entity 1100. Network entity 1100, under control of controller 280, transmits and receives signals via wireless radios 1101a-r and antennas 252a-r. Wireless radios 1101a-r include various components and hardware, as illustrated in FIG. 2 for UE 115, including modulator and demodulators 254a-r, MIMO detector 256, receive processor 258, transmit processor 264, and TX MIMO processor 266. As another example, network entity 1100 may include or correspond to a base station, such as base station 105 of FIG. 2. In such implementations, wireless radios 1101a-t include various components and hardware, as illustrated in FIG. 2 for base station 105, including modulator and demodulators 232a-t, transmit processor 220, TX MIMO processor 230, MIMO detector 236, and receive processor 238.

As shown, memory 282 may include information 1102, sensor sharing configuration 1105, and communication logic 1106. Information 1102 may include road congestion information 1103, travel information 1104, or a combination thereof. Road congestion information 1103 may include or correspond to road congestion information 470. Travel information 1104 may include or correspond to travel information 406. Sensor sharing configuration 1105 may include or correspond to sensor sharing configuration indicator 471, sensor sharing configuration message 472, indicators 474, parameters 476, sensor sharing configuration 407, or a combination thereof. Communication logic 1106 may be configured to enable communications between one or more UEs (e.g., UE 115), one or more base stations (e.g., base station 105), one or more network entities (e.g., network entity 430), one or more network vehicles (e.g., vehicle 401, vehicle 422, vehicle 1000), another server (e.g., map service server 490 or a server as illustrated in FIG. 12), or core network 130 or a management function.

FIG. 12 is a block diagram of an example server 1200 that supports a sensor sharing configuration according to one or more aspects. Server 1200 may be configured to perform operations, including the blocks of the process described with reference to FIG. 1, 4, or 5-7. In some implementations, server 1200 includes the structure, hardware, and components shown and described with reference to base station 105, core network 130, or server 450. For example, server 1200 may include controller 240, which operates to execute logic or computer instructions stored in memory 242, as well as controlling the components of server 1200 that provide the features and functionality of server 1200. Server 1200, under control of controller 240, transmits and receives signals via wireless radios 1201a-t and antennas 234a-t. Wireless radios 1201a-t include various components and hardware, as illustrated in FIG. 2 for base station 105, including modulator and demodulators 232a-t, transmit processor 220, TX MIMO processor 230, MIMO detector 236, and receive processor 238. Although server 1200 is described as including wireless radios 1201a-t and antennas 234a-t, in other implementations, server 1200 may additionally or alternatively include an interface, such as an interface configured for wired communication.

As shown, the memory 242 may include information 1202, sensor sharing control logic 1205, sensor sharing configuration 1206, and communication logic 1207. Information 1202 may include road congestion information 1203, travel information 1204, or a combination thereof. Road congestion information 1203 may include or correspond to road congestion information 470. Travel information 1204 may include or correspond to travel information 406. Sensor sharing control logic 1205 may be configured to generate or determine sensor sharing configuration 1206. Sensor sharing configuration 1206 may include or correspond to sensor sharing configuration indicator 471, sensor sharing configuration message 472, indicators 474, parameters 476, sensor sharing configuration 407, or a combination thereof. Communication logic 1207 may be configured to enable communication between server 1200 and one or more other devices. Server 1200 may receive signals from or transmit signals to one or more UEs (e.g., UE 115), one or more base stations (e.g., base station 105), one or more network entities (e.g., network entity 430 or network entity 1100), one or more network vehicles (e.g., vehicle 401, vehicle 422, vehicle 1000), another server (e.g., map service server 490), or core network 130 or a management function.

It is noted that one or more blocks (or operations) described with reference to FIGS. 6-9 may be combined with one or more blocks (or operations) described with reference to another of the figures. For example, one or more blocks (or operations) of FIG. 6 may be combined with one or more blocks (or operations) of FIG. 7. As another example, one or more blocks associated with FIG. 6 or 7 may be combined with one or more blocks (or operations) associated with FIG. 8. As another example, one or more blocks associated with FIG. 9 may be combined with one or more blocks (or operations) associated with FIG. 6, 7, or 8. Additionally, or alternatively, one or more operations described above with reference to FIGS. 1-5 may be combined with one or more operations described with reference to FIGS. 6-9.

In one or more aspects, techniques for a sensor sharing configuration may include additional aspects, such as any single aspect or any combination of aspects described below or in connection with one or more other processes or devices described elsewhere herein. In a first aspect, techniques for a sensor sharing configuration may include receiving road congestion information associated with one or more regions. The techniques may further include receiving travel information associated with one or more vehicles. The techniques may also include transmitting an indicator of a sensor sharing configuration for the one or more vehicles. The sensor sharing configuration is based on the road congestion information and the travel information. In some examples, the techniques in the first aspect may be implemented in a method or process, such as a method of communication performed by a network entity. In some other examples, the techniques of the first aspect may be implemented in a wireless communication device, such as a vehicle or UE, which may include a vehicle, a component of a vehicle, a UE, or a component of a UE. In some examples, the wireless communication device may include at least one processing unit or system (which may include an application processor, a modem or other components) and at least one memory device coupled to the processing unit. The processing unit or system may be configured to perform operations described herein with respect to the wireless communication device. In some examples, the memory device includes a non-transitory, computer-readable medium storing instructions or having program code stored thereon that, when executed by the processing unit or system, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the travel information indicates, for a first vehicle of the one or more vehicles, a position of the first vehicle, a speed of the first vehicle, a heading of the first vehicle, a direction of travel of the first vehicle, or a combination thereof.

In a third aspect, in combination with one or more of the first aspect or the second aspect, the travel information includes one or more BSMs, one or more CAMs, one or more CPMs, one or more SDSMs, or a combination thereof.

In a fourth aspect, in combination with one or more of the first aspect through the third aspect, the indicator of the sensor sharing configuration indicates one or more sensor sharing mitigation techniques to be performed at the one or more vehicles.

In a fifth aspect, in combination with the fourth aspect, the one or more sensor sharing mitigation techniques include a frequency-based mitigation technique, a distance-based mitigation technique, a dynamics-based mitigation technique, a confidence-based mitigation technique, an entropy-based mitigation technique, an object self-announcement-based mitigation technique, or a combination thereof.

In a sixth aspect, in combination with the fourth aspect, the indicator of the sensor sharing configuration further indicates one or more parameters associated with the one or more sensor sharing mitigation techniques.

In a seventh aspect, in combination with the sixth aspect, the one or more parameters include a temporal window, detection instances, a threshold distance, a threshold speed, or a combination thereof.

In an eighth aspect, in combination with one or more of the first aspect through the seventh aspect, the techniques further include identifying, based on the travel information, a destination region of the one or more regions in which the one or more vehicles are expected to be located at a future time.

In a ninth aspect, in combination with the eighth aspect, the techniques further include determining a road congestion metric associated with the destination region based on the road congestion information.

In a tenth aspect, in combination with the ninth aspect, the techniques further include generating the indicator of the sensor sharing configuration based on a comparison of the road congestion metric to a threshold.

In an eleventh aspect, in combination with the tenth aspect, to generate the indicator of the sensor sharing configuration, the techniques further include determining the sensor sharing configuration to increase sensor sharing mitigation at the one or more vehicles based on the road congestion metric satisfying the threshold.

In a twelfth aspect, in combination with the tenth aspect, to generate the indicator of the sensor sharing configuration, the techniques further include determining the sensor sharing configuration to decrease sensor sharing mitigation at the one or more vehicles based on the road congestion metric satisfying the threshold.

In a thirteenth aspect, in combination with the tenth aspect, the techniques further include receiving map data associated with the one or more vehicles.

In a fourteenth aspect, in combination with the thirteenth aspect, the destination region is identified based further on the map data.

In a fifteenth aspect, in combination with the tenth aspect, the techniques further include receiving tracking data associated with the one or more vehicles.

In a sixteenth aspect, in combination with the fifteenth aspect, the destination region is identified based further on the tracking data.

In a seventeenth aspect, in combination with the tenth aspect, the destination region is determined based further on road topology information associated with a road on which the one or more vehicles are traveling.

In an eighteenth aspect, in combination with the tenth aspect, the destination region is determined based further on historical travel data associated with the one or more vehicles.

In a nineteenth aspect, in combination with one or more of the first aspect through the eighteenth aspect, to transmit the indicator of the sensor sharing configuration, the techniques further include initiating transmission of the indicator via one or more downlink communications.

In a twentieth aspect, in combination with the nineteenth aspect, the one or more vehicles include a single vehicle.

In a twenty-first aspect, in combination with the twentieth aspect, the indicator of the sensor sharing configuration is included in an RRC message.

In a twenty-second aspect, in combination with the nineteenth aspect, the one or more vehicles includes multiple vehicles.

In a twenty-third aspect, in combination with the twenty-second aspect, the indicator of the sensor sharing configuration is included in an SIB message.

In a twenty-third aspect, in combination with one or more of the first aspect through the twenty-second aspect, the one or more vehicles includes a single vehicle.

In a twenty-fifth aspect, in combination with the twenty-fourth aspect, the indicator is transmitted to another network entity to cause the other network entity to transmit the sensor sharing configuration to the single vehicle via a sidelink communication.

In a twenty-sixth aspect, in combination with the twenty-fifth aspect, the indicator of the sensor sharing configuration is included in a sidelink RRC message or a sidelink signaling message.

In a twenty-seventh aspect, in combination with one or more of the first aspect through the twenty-sixth aspect, the indicator is transmitted to one or more network entities to cause the one or more other network entities to broadcast the sensor sharing configuration via one or more sidelink communications.

In a twenty-eighth aspect, in combination with one or more of the first aspect through the twenty-seventh aspect, the at least one processor, to transmit the indicator of the sensor sharing configuration, is configured to cause one or more other network entities to transmit the sensor sharing configuration to vehicles that are located within a particular range from the one or more other network entities via one or more sidelink communications.

In a twenty-ninth aspect, in combination with one or more of the first aspect through the twenty-eighth aspect, the road congestion information includes one or more BSMs, one or more CAMs, or a combination thereof, from one or more RSUs located within the one or more regions.

In a thirtieth aspect, in combination with one or more of the first aspect through the twenty-ninth aspect, the road congestion information includes one or more CBR measurements reported by vehicles, RSUs, or a combination thereof, located within the one or more regions.

In a thirty-first aspect, in combination with one or more of the first aspect through the thirtieth aspect, the road congestion information includes one or more CBR measurements reported by one or more base stations that serve the one or more regions.

In a thirty-second aspect, in combination with one or more of the first aspect through the thirty-first aspect, the road congestion information includes traffic camera data associated with the one or more regions, lane metering data associated with the one or more regions, temporal congestion data associated with the one or more regions, or a combination thereof.

In a thirty-third aspect, in combination with one or more of the first aspect through the thirty-second aspect, the techniques further include receiving second travel information associated with one or more other vehicles.

In a thirty-fourth aspect, in combination with the thirty-fourth aspect, the techniques further include transmitting a second indicator of a second sensor sharing configuration for the one or more other vehicles, the second sensor sharing configuration based on the road congestion information and the second travel information.

In a thirty-fifth aspect, in combination with the thirty-third aspect, the sensor sharing configuration is associated with a first destination region of the one or more regions that is different than the second sensor sharing configuration that is associated with a second destination region of the one or more regions. In some such aspects, the second destination region is different from the first destination region.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some such implementations, a processor (e.g., one or more processors) configured to perform an operation may include a single processor configured to perform the operation, or multiple computing devices configured to, each individually or as an aggregate, perform the operation. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. The terms “a” and “an” are defined as one or more unless this disclosure explicitly requires otherwise.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of communication performed by a network entity, the method comprising:
receiving road congestion information associated with one or more regions;
receiving travel information associated with one or more vehicles; and
transmitting an indicator of a sensor sharing configuration for the one or more vehicles, the sensor sharing configuration based on the road congestion information and the travel information.

2. The method of claim 1, wherein the travel information indicates, for a first vehicle of the one or more vehicles, a position of the first vehicle, a speed of the first vehicle, a heading of the first vehicle, a direction of travel of the first vehicle, or a combination thereof.

3. The method of claim 1, wherein the travel information includes one or more basic safety messages (BSMs), one or more cooperative awareness messages (CAMs), one or more collective perception messages (CPMs), one or more sensor data sharing messages (SDSMs), or a combination thereof.

4. The method of claim 1, wherein the indicator of the sensor sharing configuration indicates one or more sensor sharing mitigation techniques to be performed at the one or more vehicles.

5-14. (canceled)

15. A network entity configured for communication, the network entity comprising:
a memory storing processor-readable code; and
at least one processor coupled to the memory, the at least one processor configured to execute the processor-readable code to cause the at least one processor to:
receive road congestion information associated with one or more regions;
receive travel information associated with one or more vehicles; and
transmit an indicator of a sensor sharing configuration for the one or more vehicles, the sensor sharing configuration based on the road congestion information and the travel information.

16. The network entity of claim 15, wherein the at least one processor, to transmit the indicator of the sensor sharing configuration, is configured to:
initiate transmission of the indicator via one or more downlink communications.

17. The network entity of claim 16, wherein the one or more vehicles include a single vehicle, and wherein the indicator of the sensor sharing configuration is included in a radio resource control (RRC) message.

18. The network entity of claim 16, wherein the one or more vehicles includes multiple vehicles, and wherein the indicator of the sensor sharing configuration is included in a system information block (SIB) message.

19. The network entity of claim 15, wherein the one or more vehicles includes a single vehicle, and wherein the indicator is transmitted to another network entity to cause the other network entity to transmit the sensor sharing configuration to the single vehicle via a sidelink communication.

20. The network entity of claim 19, wherein the indicator of the sensor sharing configuration is included in a sidelink radio resource control (RRC) message or a sidelink signaling message.

21. The network entity of claim 15, wherein the indicator is transmitted to one or more other network entities to cause the one or more other network entities to broadcast the sensor sharing configuration via one or more sidelink communications.

22. The network entity of claim 15, wherein the at least one processor, to transmit the indicator of the sensor sharing configuration, is configured to:
cause one or more other network entities to transmit the sensor sharing configuration to vehicles that are located within a particular range from the one or more other network entities via one or more sidelink communications.

23. An apparatus for communication, the apparatus comprising:
means for receiving road congestion information associated with one or more regions;
means for receiving travel information associated with one or more vehicles; and
means for transmitting an indicator of a sensor sharing configuration for the one or more vehicles, the sensor sharing configuration based on the road congestion information and the travel information.

24. The apparatus of claim 23, wherein the road congestion information includes one or more basic safety messages (BSMs), one or more cooperative awareness messages (CAMs), or a combination thereof, from one or more roadside units (RSUs) located within the one or more regions.

25. The apparatus of claim 23, wherein the road congestion information includes one or more channel busy ratio (CBR) measurements reported by vehicles, roadside units (RSUs), or a combination thereof, located within the one or more regions.

26. The apparatus of claim 23, wherein the road congestion information includes one or more channel busy ratio (CBR) measurements reported by one or more base stations that serve the one or more regions.

27. The apparatus of claim 23, wherein the road congestion information includes traffic camera data associated with the one or more regions, lane metering data associated with the one or more regions, temporal congestion data associated with the one or more regions, or a combination thereof.

28. A non-transitory, computer-readable medium storing instructions that, when executed by a processor, cause the processor to perform operations comprising:
receiving road congestion information associated with one or more regions;
receiving travel information associated with one or more vehicles; and
transmitting an indicator of a sensor sharing configuration for the one or more vehicles, the sensor sharing configuration based on the road congestion information and the travel information.

29. The non-transitory, computer-readable medium of claim 28, wherein the operations further comprise:
receiving second travel information associated with one or more other vehicles; and
transmitting a second indicator of a second sensor sharing configuration for the one or more other vehicles, the second sensor sharing configuration based on the road congestion information and the second travel information.

30. The non-transitory, computer-readable medium of claim 29,
wherein the sensor sharing configuration is associated with a first destination region of the one or more regions that is different than the second sensor sharing configuration that is associated with a second destination region of the one or more regions, the second destination region different from the first destination region.
